(19) United States
(12) Patent Application Publication
(10) Pub. No.: US 2026/0369879 A1
(43) Pub. Date: Nov. 19, 2026

(54) BASE STATION ANTENNAS HAVING ANTENNA ARRAYS THAT GENERATE ANTENNA BEAMS WITH ELECTRONIC TILT THAT VARIES AS A FUNCTION OF AZIMUTH ANGLE

(71) Applicant: Outdoor Wireless Networks LLC, Richardson, TX (US)

(72) Inventors: Peter J. Bisiules, LaGrange Park, IL (US); Sammit Patel, Dallas, TX (US); Chengcheng Tang, Murphy, TX (US); Bo Wu, Allen, TX (US); XiaoHua Hou, Richardson, TX (US); Haifeng Li, Allen, TX (US)

(21) Appl. No.: 19/300,000

(22) Filed: Aug. 14, 2025

Related U.S. Application Data
(60) Provisional application No. 63/683,994, filed on Aug. 16, 2024.
(60) Provisional application No. 63/793,007, filed on Apr. 23, 2025.

(51) Int. Cl. H01Q 3/22; H01Q 1/24; H01Q 3/00; H01Q 3/30; H01Q 19/10; H01Q 21/08

(52) U.S. Cl. CPC H01Q 3/22; H01Q 1/246; H01Q 3/005; H01Q 3/30; H01Q 19/10; H01Q 21/08

(57) ABSTRACT

A base station antennas comprises a linear array of radiating elements that is configured to generate an antenna beam having a main lobe that has a first amount of electronic downtilt in a first pointing direction in the azimuth plane and that has a second amount of electronic downtilt in a second pointing direction in the azimuth plan, where the second amount of electronic downtilt exceeds the first amount of electronic downtilt by at least 1°.

### CROSS-REFERENCE TO RELATED APPLICATIONS

The present application claims priority under 35 U.S.C. § 119 to U.S. Provisional Application Ser. No. 63/793,007, filed Apr. 23, 2025 and to U.S. Provisional Application Ser. No. 63/683,994, filed Aug. 16, 2024, the entire content of both of which are incorporated herein by reference.

### FIELD

The present invention generally relates to radio communications and, more particularly, to base station antennas for cellular communications systems.

### BACKGROUND

Cellular communications systems are well known in the art. In a cellular communications system, a geographic area is divided into a series of regions that are referred to as “cells” which are served by respective base stations. Each base station includes baseband equipment, radios and base station antennas that are configured to provide two-way radio frequency (“RF”) communications with subscribers that are positioned throughout the cell served by the base station. The base station antennas are often mounted on a tower or other raised structure, with the radiation pattern (“antenna beam”) that is generated by each antenna directed outwardly to serve a respective sector. Typically, a base station antenna includes multiple phase-controlled arrays of radiating elements, with the radiating elements arranged in vertically-extending columns that are referred to as “linear arrays.” It will be appreciated that these vertically-extending columns of radiating elements may be straight columns of radiating elements or columns in which some of the radiating elements are staggered horizontally or even situations where two radiating elements are horizontally aligned, as offsetting some radiating elements in the horizontal direction acts to narrow the beamwidths of the generated antenna beams in the azimuth (horizontal) plane. Herein, the term “linear array” is used broadly to encompass all of the above configurations. Herein, “vertical” refers to a direction that is generally perpendicular relative to the plane defined by the horizon.

Most cells in a cellular communications system are divided into a plurality of “sectors,” and separate base station antennas provide coverage (service) to each of the sectors. The most common base station configuration is the so-called “three sector configuration” in which a cell is divided into three 120° “sectors” in the “azimuth plane.” The “azimuth” plane refers to a horizontal plane that bisects the base station antenna that is parallel to the plane defined by the horizon. References will also be made herein to the “elevation plane,” which refers to a plane that extends vertically (i.e., perpendicular to the horizon) that bisects the base station antenna in the front-to-back direction. Each sector in a three sector configuration may have a hexagonal shape when viewed from above. In a three sector configuration, the antenna beams generated by the linear arrays typically have half power beamwidths in the azimuth plane (“azimuth HPBW”) of about 65° (i.e., the angle subtended in the azimuth plane by the portion of the antenna beam that has a gain that is within 3 dB of the peak gain is about 65°). Generally speaking, an antenna beam having an azimuth HPBW of about 65° will provide reasonably good coverage throughout a 120° sector without having excessive spillover of RF energy into adjacent sectors. Such spillover of RF energy into adjacent sectors is undesirable both because it reduces the gain of the antenna beam within the sector and because the spillover appears as interference to the antenna beams covering the adjacent sectors.

Typically, each base station antenna will include multiple linear arrays of radiating elements that operate, for example, using second generation (“2G”), third generation (“3G”), fourth generation (“4G”) or fifth generation (“5G”) cellular network protocols. Most modern base station antennas include both “low-band” linear arrays of radiating elements that support service in some or all of the 617-960 MHz frequency band and “mid-band” linear arrays of radiating elements that support service in some or all of the 1427-2690 MHz frequency band, Each linear array is typically formed using dual-polarized radiating elements that include first and second polarization radiators, which allows the linear array to transmit and receive RF signals at two orthogonal polarizations. The first polarization radiators of the radiating elements in a linear array are all coupled to a first RF signal source (typically a first port of a radio), and the second polarization radiators of the radiating elements in the linear array are all coupled to a second RF signal source (typically a second port of the radio). Modern base station antennas may also include arrays of high-band radiating elements that support service in some or all of, for example, the 3.0-5.0 GHz frequency band. The high-band arrays are typically multi-column arrays that are coupled to beamforming radios that generate narrower, higher gain antenna beams that can by electronically steered throughout a coverage area. Beamforming arrays are also sometimes formed using multi-column arrays of mid-band radiating elements.

An RF signal that is to be transmitted by a linear array is passed from a radio port to the antenna where it is divided into a plurality of sub-components, with each sub-component fed to a respective subset of the radiating elements in the linear array (typically each sub-component is fed to between one and three radiating elements). The sub-components of the RF signal are transmitted through the radiating elements to generate an antenna beam that covers a generally fixed coverage area, such as a sector of a cell. Since the antenna beams generated by the above-described 2G/3G/4G/5G linear arrays have a fixed or “static” shape, the 2G/3G/4G/5G linear arrays are often referred to as “passive” linear arrays, in contrast to the above-described “active” multi-column arrays that generate antenna beams having shapes and pointing directions that can be dynamically changed.

A passive linear array of radiating elements will generate an antenna beam at each polarization that has a fixed shape, with the azimuth HPBW and the 10 dB azimuth beamwidth of these antenna beams set to provide coverage to a sector while reducing, to the extent possible, spillover of RF energy into neighboring sectors. Almost all modern base station antennas also have remote electronic tilt capabilities, which refers to an ability of a network operator to change the tilt angle of the antenna beam in the elevation plane (i.e., the vertical angle with respect to the horizon at which the antenna beam has the highest gain) by simply sending control signals to the base station antenna. Remote electronic tilt capabilities are important because the tilt angle of an antenna beam determines how far the RF energy will extend outwardly from the base station antenna before most of the energy is absorbed into the ground.

If the tilt angle for an antenna beam is set to 0° (i.e., the boresight pointing direction of the antenna beam extends along a plane that is parallel to the horizon), the antenna beam may travel large distances, particularly in areas where the terrain is flat. Such a tilt angle is appropriate for base stations in sparsely populated areas that have few base stations, as it allows the antenna beams generated by the base station antennas to cover large geographic areas. In contrast, in heavily populated areas, base stations of a cellular network may be located in relatively close proximity to each other to increase the overall capacity of the cellular network. In order to prevent the antenna beams generated by a base station antenna in a first cell from heavily interfering with the antenna beams generated by a base station antenna in a neighboring second cell, the antenna beams in both cells may be electronically adjusted to have negative tilt angles (referred to herein as “downtilt”) so that most of the RF energy of the antenna beams will not travel as far from the base station antenna, but instead will be directed into the ground within a defined region. Generally speaking, the larger the downtilt angle of an antenna beam, the smaller the region that will be covered by the antenna beam. Herein, references to “tilt angles” refer to the actual angle of the antenna beam with respect to the horizon, and hence tilt angles may be positive or negative (and are usually negative in typical cellular systems). In contrast, references to downtilt angles refer to the amount that an antenna beam is tilted below the plane defined by the horizon. Thus, a positive downtilt angle will have a negative tilt angle (e.g., a downtilt angle of 5° corresponds to a tilt angle of −5°). Cellular operators typically set the downtilt angles for the antenna beams generated by the base station antennas in their networks to be in the range of, for example, about 0° to about 10° (i.e., tilt angles of about 0° to about −10°) so that neighboring cells will not experience high levels of interference.

A cellular network operator can change the tilt angle of an antenna beam generated by a linear array in a base station antenna by transmitting a control signal to the antenna that cause the antenna to alter the phases of the sub-components of the RF signals that are transmitted and received by the individual radiating elements of the linear array. In particular, to electronically downtilt an antenna beam generated by an array of radiating elements, a phase taper may be applied across the radiating elements of the array. Such a phase taper may be applied by adjusting the settings on a phase shifter that is positioned along the RF transmission path between a radio and the individual radiating elements of the array.

One widely-used type of phase shifter is an electromechanical “wiper” phase shifter that includes a main printed circuit board and a “wiper” printed circuit board that may be rotated above the main printed circuit board. Such wiper phase shifters typically divide an input RF signal that is received at the main printed circuit board into a plurality of sub-components, and then couple at least some of these sub-components to the wiper printed circuit board. The sub-components of the RF signal may be coupled from the wiper printed circuit board back to the main printed circuit board along a plurality of arc-shaped traces, where each arc has a different diameter. Each end of each arc-shaped trace may be connected to a respective sub-group of radiating elements. By mechanically rotating the wiper printed circuit board above the main printed circuit board, the locations where the sub-components of the RF signal couple back to the main printed circuit board may be changed, which thus changes the lengths of the transmission paths from the phase shifter to the respective sub-groups of radiating elements. The changes in these path lengths result in changes in the phases of the respective sub-components of the RF signal, and since the arcs have different radii, the phase changes along the different paths will be different. Exemplary phase shifters of this variety are discussed in U.S. Pat. No. 7,907,096 to Timofeev, the disclosure of which is hereby incorporated herein in its entirety. Typically, the phase taper is applied by applying positive phase shifts of various magnitudes (e.g., +X°, +2X° and +3X°) to some of the sub-components of the RF signal and by applying negative phase shifts of the same magnitudes (e.g., −X°, −2X° and −3X°) to additional of the sub-components of the RF signal. Other electromechanical phase shifters, such as trombone or sliding dielectric phase shifters, may alternatively be used, as may a wide variety of electronic phase shifters.

Base station antennas that use electromechanical phase shifters typically include a plurality of so-called RET units that are used to move the moveable elements of the phase shifters (e.g., the wiper printed circuit boards) associated with the respective arrays of radiating elements. Each RET unit may include an actuator (e.g., a motor) and an output member that moves (e.g., linearly or rotationally) in response to movement of the actuator. In order to change the downtilt angle of an antenna beam generated by an array of radiating elements of a base station antenna, a control signal may be transmitted to the antenna that causes an actuator associated with the array to generate a desired amount of movement in an output member thereof. A mechanical linkage that extends between the output member of the actuator and the moveable element of a phase shifter associated with the array is used to translate the movement of the output member to movement of the moveable element of the phase shifter (e.g., a wiper arm).

### SUMMARY

Pursuant to embodiments of the present invention, base station antennas are provided that comprise a linear array of radiating elements that is configured to generate an antenna beam having a main lobe that has a first amount of electronic downtilt in a first pointing direction in the azimuth plane and that has a second amount of electronic downtilt in a second pointing direction in the azimuth plane, where the second amount of electronic downtilt exceeds the first amount of electronic downtilt by at least 1°.

In some embodiments, the second amount of electronic downtilt may exceed the first amount of electronic downtilt by at least 2°, by at least 3°, or by at least 5°.

In some embodiments, the first pointing direction in the azimuth plane is a boresight pointing in the azimuth plane. In some embodiments, the second pointing direction in the azimuth plane is at an azimuth angle that is between −60° and −15° or at an azimuth angle that is between 15° and 60°, or at an azimuth angle that is between −60° and −20° or at an azimuth angle that is between 20° and 60°, or at an azimuth angle that is between −30° and −60° or at an azimuth angle that is between 30° and 60°.

In some embodiments, the base station antenna is a sector antenna of a cellular network, and the antenna beam that is generated by the linear array is configured to cover a 1200 sector in the azimuth plane.

In some embodiments, the main lobe may have an amount of electronic downtilt as a function of azimuth angle that monotonically increases over a first range of at least 10° of the azimuth angles subtended by the main lobe. In some embodiments, the main lobe may also have an amount of electronic downtilt as a function of azimuth angle that monotonically increases over a second range of at least 10° of the azimuth angles subtended by the main lobe, where the first range does not overlap the second range. In some embodiments, an azimuth angle corresponding to a boresight pointing direction of the main lobe is in between the first range and the second range.

Pursuant to further embodiments of the present invention, base station antennas are provided that comprise a linear array of radiating elements and a plurality of parasitic elements that are configured to change an amount of electronic downtilt applied to a portion of the main lobe of an antenna beam generated by the linear array, where the portion comprises less than all of the azimuth angles subtended by the main lobe.

In some embodiments, the parasitic elements are configured to increase the amount of electronic downtilt applied to the portion of the main lobe of the antenna beam generated by the linear array. In such embodiments, the portion of the main lobe of the antenna beam generated by the linear array for which the parasitic elements are configured to increase the amount of electronic downtilt does not include a portion of the main lobe that is directed in the boresight pointing direction.

In some embodiments, the parasitic elements are configured to decrease the amount of electronic downtilt applied to the portion of the main lobe of the antenna beam generated by the linear array. In such embodiments, the portion of the main lobe of the antenna beam generated by the linear array for which the parasitic elements are configured to decrease the amount of electronic downtilt does includes a portion of the main lobe that is directed in the boresight pointing direction.

In some embodiments, the parasitic elements are configured to change the amount of electronic downtilt applied to the portion of the main lobe of an antenna beam generated by the linear array by at least 1°, or by at least 3°, or by at least 5°. In some embodiments, the base station antenna is a sector antenna of a cellular network, and the antenna beam that is generated by the linear array is configured to cover a 120° sector in the azimuth plane.

In some embodiments, the main lobe has an amount of electronic downtilt that monotonically increases as the azimuth angle moves away from a boresight azimuth angle for at least a range of 10° of azimuth angles. In some embodiments, an amount of electronic downtilt increases monotonically from an azimuth angle that is offset in the azimuth plane by 300-600 from an azimuth angle of the boresight pointing direction of the main lobe.

Pursuant to further embodiments of the present invention, base station antennas are provided that comprise a first RF port; an antenna array that includes a plurality of radiating elements, each radiating element including a first polarization radiator, where the first polarization radiator of each radiating element in the antenna array is coupled to the first RF port; and an adjustable pattern control system that is configured to adjust an average amount of electronic downtilt applied to a first outer portion of a main lobe of an antenna beam that is generated in response to an RF signal input at the first RF port relative to an average amount of electronic downtilt applied to a central portion of the main lobe, where the first outer portion of the main lobe comprises a first portion of the main lobe that is directed at a first range of azimuth angles and the central portion of the main lobe comprises a second portion of the main lobe that is directed at a second range of azimuth angles that do not overlap with the first range of azimuth angles and that are closer to an azimuth angle of the boresight pointing direction of the antenna beam than the azimuth angles in the first range of azimuth angles.

In some embodiments, the adjustable pattern control system is further configured to adjust an average amount of electronic downtilt applied to a second outer portion of the main lobe relative to the average amount of electronic downtilt applied to the central portion of the main lobe, where the second outer portion of the main lobe comprises a third portion of the main lobe that is directed at a third range of azimuth angles that do not overlap with the second range of azimuth angles. In some embodiments, the second range of azimuth angles is in between the first and third ranges of azimuth angles. In some embodiments, the second range of azimuth angles comprises azimuth angles that are less than 30° from the azimuth angle of the boresight pointing direction of the antenna beam, the first range of azimuth angles comprises azimuth angles that are between −30° and −60° of the azimuth angle of the boresight pointing direction of the antenna beam, and the third range of azimuth angles comprises azimuth angles that are between 30° and 60° of the azimuth angle of the boresight pointing direction of the antenna beam.

In some embodiments, the first outer portion, the second outer portion and the central portion of the antenna beam each encompass one third of the azimuth angles covered by the main lobe.

In some embodiments, the antenna beam is configured to provide coverage to a 120° sector in the azimuth plane of a cell of a cellular network.

In some embodiments, the adjustable pattern control system is configured to apply at least 1° more electronic downtilt, on average, to the first outer portion of the main lobe than is applied, on average, to the central portion of the main lobe.

In some embodiments, the adjustable pattern control system is configured to apply at least 2° more electronic downtilt, on average, to the first outer portion of the main lobe of the antenna beam than is applied, on average, to the central portion of the antenna beam.

In some embodiments, the base station antenna further comprises a remote electronic tilt system that is configured to adjust the boresight pointing direction of the antenna beam in the elevation plane in response to control signals received from a remote location.

In some embodiments, the base station antenna further comprises a reflector that extends in a longitudinal direction of the base station antenna, where the radiating elements extend forwardly from the reflector in a depth direction of the base station antenna that is perpendicular to the longitudinal direction. In some embodiments, the adjustable pattern control system comprises a plurality of phase delay elements that are configured to adjust phases of RF energy emitted by at least some of the radiating elements of the antenna array.

In some embodiments, the base station antenna further comprises a motor and a mechanical linkage that are configured to move at least some of the phase delay elements.

In some embodiments, the phase delay elements comprise electronically adjustable phase delay elements.

Pursuant to still further embodiments of the present invention, base station antennas are provided that comprise a reflector that extends in a longitudinal direction of the base station antenna; a first RF port; an antenna array that includes a plurality of radiating elements that extend forwardly from the reflector in a depth direction of the base station antenna, the depth direction perpendicular to the longitudinal direction, where each radiating element comprises a first polarization radiator that is coupled to the first RF port; and a plurality of phase adjustment elements that are configured to selectively adjust the phases of RF energy emitted by at least some of the respective radiating elements in the antenna array.

In some embodiments, the antenna array is configured so that RF radiation emitted in a broadside pointing direction of the antenna array by each radiating element in the antenna array is in-phase. In some embodiments, a first phase of the RF radiation emitted by a first of the radiating elements in the antenna array increasingly diverges from a second phase of the RF radiation emitted by a second of the radiating elements in the antenna array as the azimuth angle of the RF radiation diverges from the broadside pointing direction of the antenna array.

In some embodiments, the phase adjustment elements are positioned forwardly of the reflector. In some embodiments, the plurality of phase adjustment elements comprise a plurality of metamaterial phase adjustment elements. In some embodiments, the plurality of phase adjustment elements comprise a plurality of dielectric blocks that are mounted forwardly of respective ones of at least some of the radiating elements, and different ones of the dielectric blocks have different thicknesses.

In some embodiments, the phase adjustment elements in a first sub-set of the plurality of phase adjustment elements are configured to apply a phase lead to RF energy emitted by at least some of the radiating elements in an upper portion of the antenna array as compared to RF energy emitted by at least some of the radiating elements in a lower portion of the antenna array.

In some embodiments, the phase adjustment elements in a first sub-set of the plurality of phase adjustment elements are configured to apply a phase lag to RF energy emitted by at least some of the radiating elements in an upper portion of the antenna array as compared to RF energy emitted by at least some of the radiating elements in a lower portion of the antenna array.

In some embodiments, the plurality of phase adjustment elements are part of a adjustable pattern control system that is configured to adjust phases of RF energy emitted by at least some of the radiating elements in the antenna array in response to control signals received at the base station antenna from a remote location.

In some embodiments, the phase adjustment elements comprise moveable phase adjustment elements that are positioned farther forwardly than radiators of the radiating elements in the antenna array.

In some embodiments, the phase adjustment elements comprise metamaterial phase adjustment elements that impart phase delays that are electrically adjustable.

Pursuant to still further embodiments of the present invention, base station antennas are provided that comprise a reflector that extends in a longitudinal direction of the base station antenna; a first RF port; an antenna array that includes a plurality of radiating elements that extend forwardly from the reflector in a depth direction of the base station antenna that is perpendicular to the longitudinal direction, each radiating element including a first polarization radiator that is coupled to the first RF port; and at least first and second configurable phase adjustment elements that are mounted forwardly of respective first and second of the radiating elements in the antenna array.

In some embodiments, the first and second configurable phase adjustment elements are each metamaterial phase adjustment elements.

In some embodiments, the first and second configurable phase adjustment elements are each dielectric phase adjustment elements.

In some embodiments, the first and second phase adjustment elements are configured to apply a phase lead to RF energy emitted by the first and second of the radiating elements in the antenna array as compared to RF energy emitted by at least one other of the radiating elements in the antenna array.

In some embodiments, the first and second phase adjustment elements are configured to apply a phase lag to RF energy emitted by the first and second of the radiating elements in the antenna array as compared to RF energy emitted by at least one other of the radiating elements in the antenna array.

In some embodiments, the first and second phase adjustment elements are part of a adjustable pattern control system that is configured to adjust phases of RF energy emitted by at least some of the radiating elements in the antenna array in response to control signals received at the base station antenna from a remote location.

In some embodiments, the first and second phase adjustment elements comprise moveable phase adjustment elements that are positioned farther forwardly than radiators of the first and second of the radiating elements in the antenna array.

In some embodiments, the first and second phase adjustment elements comprise metamaterial phase adjustment elements that impart phase delays that are electrically adjustable.

Pursuant to yet additional embodiments of the present invention, methods of operating a base station antenna are provided. Pursuant to these methods, an antenna array that includes a plurality of radiating elements that extend forwardly from a reflector in a depth direction of the base station antenna is provided. A plurality of phase adjustment elements that are mounted forwardly of at least some of the radiating elements to adjust phases of sub-components of an RF signal that are emitted by respective ones of the at least some of the radiating elements to apply a variable electronic tilt to an antenna beam generated by the antenna array.

In some embodiments, the method further comprises configuring the antenna array so that RF radiation emitted by the respective radiating elements in the antenna array in a broadside pointing direction of the antenna array is in-phase.

In some embodiments, a combination of the adjustment to the phases and the configuration of the antenna array so that RF radiation emitted by the respective radiating elements in the antenna array in the broadside pointing direction of the antenna array is in-phase acts to apply the variable electronic tilt to an antenna beam generated by the antenna array.

In some embodiments, the antenna array extends in a longitudinal direction of the base station antenna that is perpendicular to the depth direction.

In some embodiments, the phase adjustment elements are each metamaterial phase adjustment elements. In some embodiments, the phase adjustment elements are configurable phase adjustment elements.

In some embodiments, the radiating elements include an upper sub-set of the radiating elements, a lower sub-set of the radiating elements and a central sub-set of the radiating elements that is between the upper and lower sub-sets of the radiating elements.

In some embodiments, the upper sub-set of the radiating elements is configured to have a phase lead in the depth direction with respect to the central sub-set of the radiating elements and the lower sub-set of the radiating elements is configured to have a phase lag in the depth direction with respect to the central sub-set of the radiating elements.

In some embodiments, the upper sub-set of the radiating elements is configured to have a phase lag in the depth direction with respect to the central sub-set of the radiating elements and the lower sub-set of the radiating elements is configured to have a phase lead in the depth direction with respect to the central sub-set of the radiating elements. In some embodiments, the phases of sub-components of the RF signal that are emitted by respective ones of the at least some of the radiating elements to apply the variable electronic tilt to the antenna beam generated by the antenna array are adjusted in response to a control signal received at the base station antenna.

In some embodiments, at least some of the plurality of phase adjustment elements are moveable phase adjustment elements. In some embodiments, at least some of the plurality of phase adjustment elements comprise metamaterial phase adjustment elements that impart phase delays that are electrically adjustable.

Pursuant to still further embodiments of the present invention, base station antennas are provided that comprise a reflector that extends in a longitudinal direction of the base station antenna; an antenna array that includes a plurality of radiating elements that extend forwardly from the reflector, where the radiating elements are spaced apart from each other in the longitudinal direction of the base station antenna; and a phase adjustment system that is configured to vary an amount of phase lag or phase lead that is present between RF radiation emitted by a first subset of one or more of the radiating elements and a second subset of one or more of the radiating elements.

In some embodiments, the first subset comprises radiating elements that are in an upper half of the antenna array and the second subset comprises radiating elements that are in a lower half of the antenna array.

Pursuant to still further embodiments of the present invention, base station antennas are provided that comprise a reflector that extends in a longitudinal direction of the base station antenna; an antenna array that includes a plurality of radiating elements, the antenna array configured to generate antenna beams that provide coverage to a sector of a cellular communications system; and a variable electronic tilt system that is configurable to adjust a difference between a first amount of electronic downtilt that is applied to the generated the antenna beams at the center of the sector and a second amount of electronic downtilt that is applied to the generated antenna beams at the edge of the sector.

Pursuant to yet additional embodiments of the present invention, methods of configuring a base station antenna are provided where the base station antenna comprises a reflector that extends in a longitudinal direction of the base station antenna and an antenna array that includes a plurality of radiating elements that extend forwardly from the reflector and that are spaced apart from each other in the longitudinal direction of the base station antenna. Pursuant to these methods, the base station antenna is configured so that first RF radiation exiting the base station antenna that is emitted by a first of the radiating elements in a broadside pointing direction of the antenna array has a phase offset with respect second RF radiation exiting the base station antenna that is emitted by a second of the radiating elements in the broadside pointing direction of the antenna array. A feed network for the antenna array is configured to reduce an amount of the phase offset between the first and second RF radiation exiting the base station antenna in the broadside pointing direction of the antenna array.

In some embodiments, the feed network for the antenna array is configured to eliminate the phase offset between the first and second RF radiation exiting the base station antenna in the broadside pointing direction of the antenna array.

In some embodiments, the first of the radiating elements is mounted above the second of the radiating elements and the base station antenna is configured so that the first RF radiation has a phase lag with respect to the second RF radiation.

In some embodiments, the first of the radiating elements is mounted above the second of the radiating elements and the base station antenna is configured so that the first RF radiation has a phase lead with respect to the second RF radiation.

In some embodiments, the reflector is a stepped reflector that includes a plurality of panels that are offset in a depth direction of the base station antenna, and wherein configuring the base station antenna so that first RF radiation exiting the base station antenna that is emitted by the first of the radiating elements has a phase offset with respect second RF radiation exiting the base station antenna that is emitted by the second of the radiating elements comprises mounting the first of the radiating elements on a first panel of a stepped reflector and mounting the second of the radiating elements on a second panel of a stepped reflector.

In some embodiments, configuring the base station antenna so that first RF radiation exiting the base station antenna that is emitted by the first of the radiating elements has a phase offset with respect second RF radiation exiting the base station antenna that is emitted by the second of the radiating elements comprises using one or more phase adjustment elements to adjust a phase of at least one of the first RF radiation and the second RF radiation.

In some embodiments, configuring the feed network for the antenna array to reduce an amount of the phase offset between the first and second RF radiation exiting the base station antenna in the broadside pointing direction of the antenna array comprises changing a path length of a feed line that feeds the first of the radiating elements.

Pursuant to still further embodiments of the present invention, base station antennas are provided that comprise an antenna array that includes a plurality of radiating elements that are spaced apart from each other in a longitudinal direction of the base station antenna, the antenna array configured to generate antenna beams that provide coverage to a sector of a cellular communications system. The antenna array is configured so that a first phase of first RF radiation emitted by a first subset of the radiating elements in an upper portion of the antenna array toward a center of the sector is equal to a second phase of second RF radiation emitted by a second subset of the radiating elements in a lower portion of the antenna array toward the center of the sector, and so that a third phase of third RF radiation emitted by the first subset of the radiating elements toward a first edge of the sector differs from a fourth phase of fourth RF radiation emitted by the second subset of the radiating elements toward the first edge of the sector.

In some embodiments, the third phase differs from the fourth phase by at least 5°.

In some embodiments, the antenna array is further configured so that a fifth phase of fifth RF radiation emitted by the first subset of the radiating elements toward a second edge of the sector differs from a sixth phase of sixth RF radiation emitted by the second subset of the radiating elements toward the second edge of the sector.

In some embodiments, a difference between the third phase and the fourth phase is the same as a difference between the fifth phase and the sixth phase.

### BRIEF DESCRIPTION OF THE DRAWINGS

FIG. 1A is an azimuth plot of an antenna beam of a typical conventional linear array that is designed to provide service to a 120° sector in the azimuth plane.

FIG. 1B is the corresponding elevation plot of the antenna beam of FIG. 1A.

FIG. 2 is a schematic plan view of a cellular network illustrating how each base station antenna may provide service to a hexagonally-shaped sector.

FIG. 3 is a schematic diagram that overlies the azimuth plot of FIG. 1A onto one of the sectors of FIG. 2.

FIG. 4 is an enlarged view of a small portion of the cellular network of FIG. 2.

FIGS. 5A and 5B are two dimensional graphs that illustrate the RF energy levels of antenna beams generated by two conventional passive linear arrays as a function of azimuth and elevation angle.

FIGS. 6A-6D are two dimensional graphs that illustrate the RF energy levels of antenna beams generated by passive linear arrays according to embodiments of the present invention as a function of azimuth and elevation angle.

FIG. 7A is a schematic front view of a base station antenna according to embodiments of the present invention that has a plurality of selective downtilt elements that are configured to variably adjust the downtilt angles of the antenna beams generated by the linear arrays in the antenna.

FIG. 7B is a schematic perspective view of an antenna assembly of the base station antenna of FIG. 7A.

FIG. 8 is a schematic view of a portion of a base station antenna according to further embodiments of the present invention.

FIG. 9A is a schematic side view of a base station antenna that illustrates how a linear array thereof can be configured to provide high signal-to-interference plus noise (“SINR”) performance.

FIG. 9B is a schematic side view of a base station antenna that illustrates how a linear array thereof can be configured to provide high coverage performance.

FIG. 10A is a schematic block diagram illustrating one example technique for mechanically switching a base station antenna between SINR and coverage modes.

FIG. 10B is a schematic block diagram illustrating another example technique for mechanically switching a base station antenna between SINR and coverage modes.

FIGS. 11A-11C are schematic front, side and end views, respectively, of a base station antenna according to further embodiments of the present invention that includes reconfigurable variable phase adjustment elements.

FIG. 12 is a schematic front view of a base station antenna according to still further embodiments of the present invention that includes moveable phase adjustment elements.

FIGS. 13A and 13B are schematic side views of base station antennas according to additional embodiments of the present invention that include dielectric phase adjustment elements.

FIG. 14A is a schematic diagram and FIG. 14B is a graph that together illustrate how the combined phase centers of the sets of radiating elements that are on the different steps of the reflector of the base station antenna of FIG. 9A differ due to the steps in the reflector.

FIG. 14B is a graph that illustrates the phase, as a function of pointing direction in the azimuth plane, of the RF radiation emitted by two of the radiating elements shown in FIG. 14A.

FIG. 14C is a graph that illustrates the normalized phase response of each set of radiating elements shown in FIG. 14A over the coverage area.

FIG. 15 is a flow chart illustrating a method of operating a base station antenna according to certain embodiments of the present invention.

FIG. 16 is a schematic perspective view of a base station antenna according to further embodiments of the present invention.

FIG. 17A is a schematic front view of a base station antenna according to additional embodiments of the present invention.

FIG. 17B is a table showing the phase difference at azimuth angles of −60° and +60° that is attributable to the different spacing between (1) the top radiating element in the first linear array in the base station antenna of FIG. 17A and the top radiating element in the second linear array in the base station antenna and (2) the bottom radiating element in the first linear array and the bottom radiating element in the second linear array.

FIG. 18A is a schematic front view of a base station antenna according to still further embodiments of the present invention that generates a variable electronic downtilt by using radiating elements having different phase centers.

FIG. 18B is a table showing the phase difference at azimuth angles of −60° and +60° that is attributable to the difference in the phase centers of the radiating elements forming the respective upper and lower portions of each linear array in the base station antenna of FIG. 18A.

FIG. 19A is a schematic perspective view of a base station antenna according to another embodiment of the present invention.

FIG. 19B is a schematic perspective view of one of the radiating elements in the base station antenna of FIG. 19A that includes parasitic monopole elements that narrow the azimuth beamwidth of the generated antenna beams.

FIG. 19C is a table showing the phase difference at azimuth angles of −60° and +60° that is attributable to the use of two different types of radiating elements in the linear arrays included in the base station antenna of FIG. 19A.

FIG. 20A is a schematic view of a wideband parasitic element that may be used in the base station antennas according to embodiments of the present invention.

FIG. 20B is a graph that illustrates the phase responses of the three parasitic elements included in the wideband parasitic element of FIG. 20A.

FIG. 21 is a schematic perspective view of a base station antenna according to still further embodiments of the present invention.

FIG. 22 is a schematic view of a parasitic element according to further embodiments of the present invention that has a primarily capacitive response.

### DETAILED DESCRIPTION

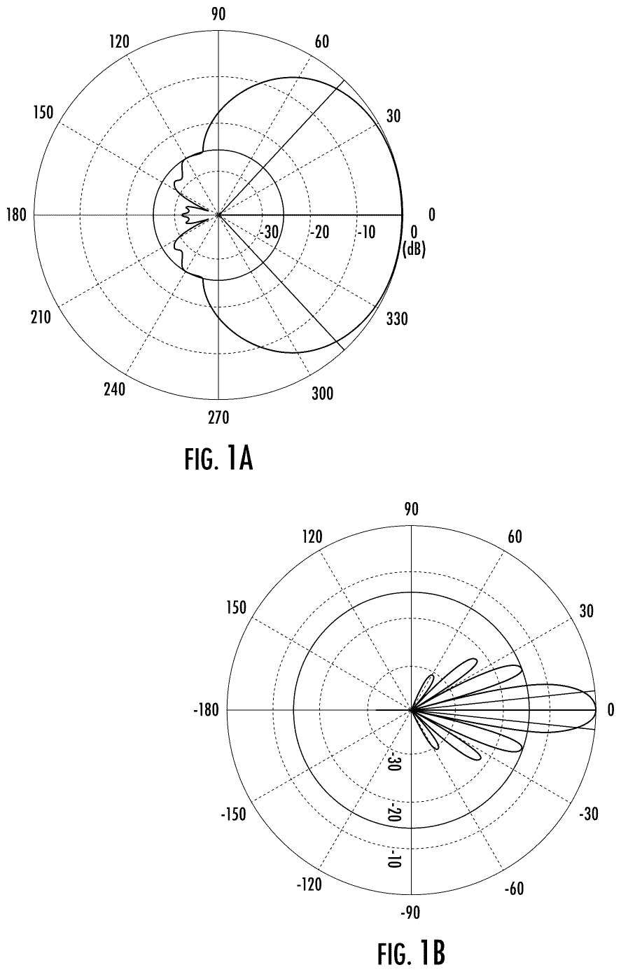

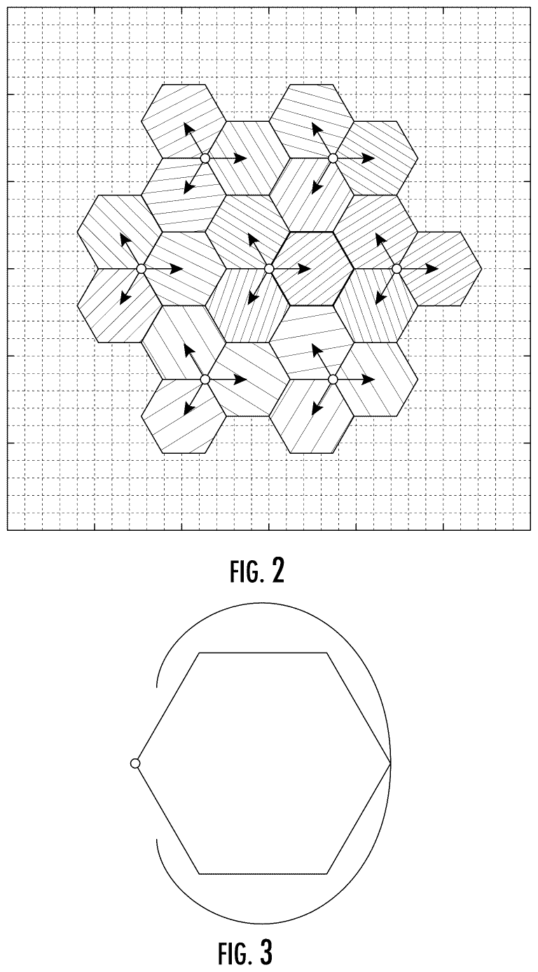

While conventional passive linear arrays provide acceptable performance, the antenna beams generated by such linear arrays have shapes that differ from the shapes of the cells in a typical cellular network. This can be seen with reference to FIGS. 1A-1B and 2. In particular, FIG. 1A is an azimuth plot of an antenna beam of a typical conventional linear array that is designed to provide service to a 120° sector in the azimuth plane, while FIG. 1B is the corresponding elevation plot for the same linear array. The azimuth plot of FIG. 1A is a horizontal cut through the three-dimensional antenna pattern of the linear array at an elevation angle of 0°, while the elevation plot of FIG. 1B is a vertical cut through the three-dimensional antenna pattern of the linear array at an azimuth angle of 0°. In FIGS. 1A and 1B the base station antenna is positioned in the middle of the diagram and the circles represent the power level of the generated antenna beam as a function of pointing angle in the azimuth (FIG. 1A) or elevation (FIG. 1B) plane normalized to the peak power level of the antenna beam. In the example of FIGS. 1A-1B, the boresight pointing direction of the antenna (i.e., the direction in which the antenna beam exhibits peak power) and can be defined by an azimuth angle and elevation angle. In the example of FIG. 1A, the boresight pointing direction is 0° in the azimuth plane and 0° in the elevation plane.

As shown in FIG. 1A, the antenna beam has a “main lobe” that has a lobe shape that extends outwardly from the base station antenna. This main lobe has an azimuth HPBW of about 65° (e.g., 55°-75°) and a 10 dB azimuth beamwidth of about 1200 (i.e., the range of azimuth angles for which the power of the main lobe is within 10 dB of the peak power). In addition, the antenna beam includes one or more small “sidelobes” where the antenna beam generates localized peaks in power at azimuth angles that are far from the azimuth angle of the boresight pointing direction of the antenna beam. The sidelobes are typically separated from the main lobe and from each other by so-called “nulls” where the power level of the antenna beam is very low. As is well understood by those of skill in the art, the linear arrays included in modern base station antennas are typically designed to operate over wide frequency ranges (e.g., hundreds to thousands of Megahertz), even though in operation the RF signals that are transmitted and received by the linear array are typically within a much smaller frequency band (e.g., 5-40 MHz). The size and shape of the antenna beams generated by a linear array will vary as a function of frequency. Unless indicated otherwise, references to characteristics of an antenna beam (e.g., its shape, size, HPBW, pointing direction, etc.) refer to the characteristic at the center frequency of the operating frequency band of the linear array.

As shown in FIG. 1B, the elevation plot has a somewhat similar shape, except that the main beam is much narrower in the elevation plane and the sidelobes are much larger in magnitude. The elevation HPBW is typically in the range of, for example, about 10°−30°. Since the beamwidth of the main lobe is much narrower in the elevation plane, the antenna beam includes more sidelobes in the elevation plane, which are once again separated from the main lobe and from each other by respective nulls.

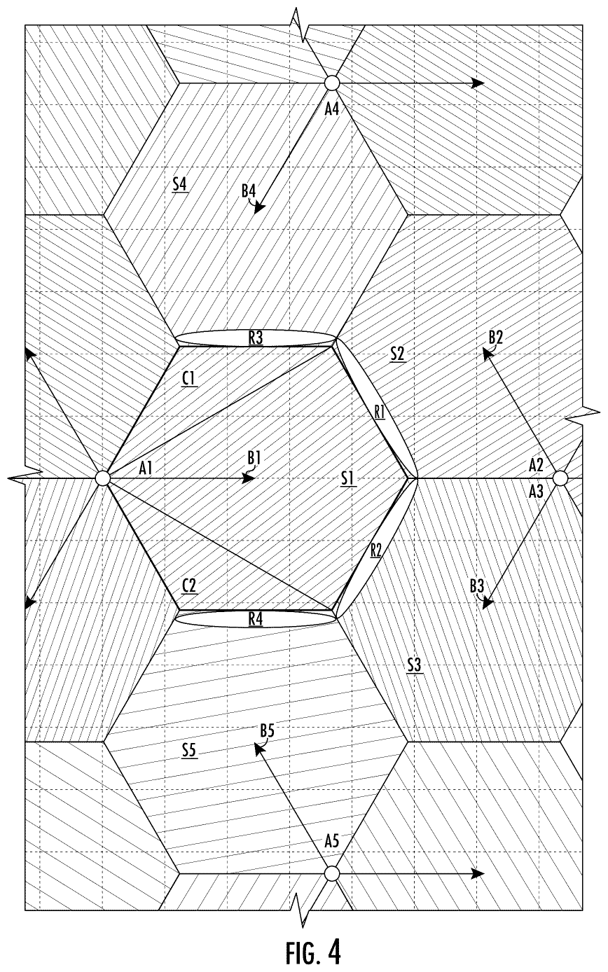

FIG. 2 is a schematic plan view of a cellular network having a three sector configuration that illustrates how each base station antenna may provide service to a hexagonally-shaped sector. The small circles in FIG. 2 represent the locations of the base stations, and the arrows extending from each small circle show the boresight pointing directions (in the azimuth plane) of the base station antennas and the linear arrays thereof. As shown in FIG. 2, the coverage area is divided into a plurality of hexagonally-shaped regions, which each comprise a “sector.” Each base station may be located at the point where three of the hexagonally-shaped regions meet, and the base station may include three base station antennas that point outwardly to provide service to the three respective sectors. Ideally, each base station antenna would generate an antenna pattern that only provided RF power within its assigned sector without spilling any RF energy over into the other sectors of the base station or into the sectors of neighboring base stations. Unfortunately, conventional antenna beams do not match the shape of the sectors, and hence conventional base station antennas generate antenna beams that spill significant amounts of RF energy into neighboring sectors. This can be seen with reference to FIG. 3.

In particular, FIG. 3 is a schematic diagram that overlies the azimuth plot of FIG. 1A onto one of the sectors of FIG. 2. As can be seen in FIG. 3, in order to have the main lobe of the antenna beam provide coverage to all of the sector, outer portions of the main lobe of the antenna beam will spill over into adjacent sectors where the RF energy will appear as interference (i.e., unwanted RF energy in the relevant frequency band) that degrades the performance of the base stations in these adjacent sectors. As can be seen from FIG. 3, the antenna beam will generate interference in all six sectors that are adjacent the sector served by the antenna beam.

In rural areas, the less than ideal shapes of conventional antenna beams may have little negative impact in practice. In these areas, base stations are typically located very far apart and the base station antennas are designed to cover large geographic regions. This allows cellular operators to minimize their investment in base stations in geographic areas that have few users. Thus, in rural areas, the base station antennas typically are configured to generate antenna beams having little or no downtilt and operate at high power levels to maximize coverage, thereby allowing the base stations to be spaced very far apart. While this may result in interference in the outer portions of the hexagonal sectors, there are typically few users in these regions and hence the negative impact of the interference is considered acceptable.

In more heavily populated areas, cellular network operators design the cells to maximize capacity. Base stations may be located in much closer proximity to each other so that users will receive higher gain signals that can support increased data rates. Unfortunately, the RF energy from a first base station antenna that spills over into sectors covered by other base station antennas may have higher power levels due to the increased gain antenna beams. This means that the amount of interference is increased, which makes it more difficult to support higher data rates. In other words, capacity will be a function of the signal-to-interference-plus-noise (“SINR”) ratio of the signals transmitted between the base station antennas and the users.

Conventionally, several techniques have been used to support higher data rates in cellular networks in highly populated areas. First, the number of base stations may be increased (and the size of existing cells shrunken accordingly) or small cell base stations may be implemented in high traffic regions of larger coverage area “macrocells.” Both of these techniques are effective at increasing capacity, but are expensive in terms of both capital expenditures and ongoing operating costs. Second, cellular operators are deploying base station antennas that operate in additional frequency bands. This is also an effective way of increasing capacity, but is also expensive. Third, cellular operators are demanding base station antennas that have higher gain antenna arrays. This approach may generally be more cost-effective than the other two approaches discussed above. Unfortunately, however, the increased antenna gain means that RF energy that spills over into adjacent sectors will have higher power levels, and hence will increase the interference levels (and degrade the SINR levels) in these adjacent cells. Thus, increasing the gain of the antenna beams has both positive and negative effects.

The impact of the interference that a first antenna beam in a first sector generates in a neighboring, second sector will depend upon (1) the magnitude of the first antenna beam along the boundary between the first and second sectors and (2) the magnitude of a second antenna beam that provides service to the second sector along the boundary between the first and second sectors. Due to the shapes of the first and second antenna beams, the magnitude of each antenna beam will vary along the boundary between the first and second sectors. The present invention is based, at least in part, on the realization that the improved performance that can be achieved in a first sector due to high antenna gain levels can more than be offset by the degradation in performance that the high antenna gain levels cause in neighboring sectors due to increased interference. Thus, if the gain of the antenna beams can be reduced at selected ranges of azimuth angles, the overall performance of a cellular network can be improved. As will be discussed in detail herein, this improvement can be achieved, for example, by electronically downtilting portions of the main lobe of an antenna beam that are at certain ranges of azimuth angles where the interference caused by the antenna beam in neighboring sectors can be particularly troublesome.

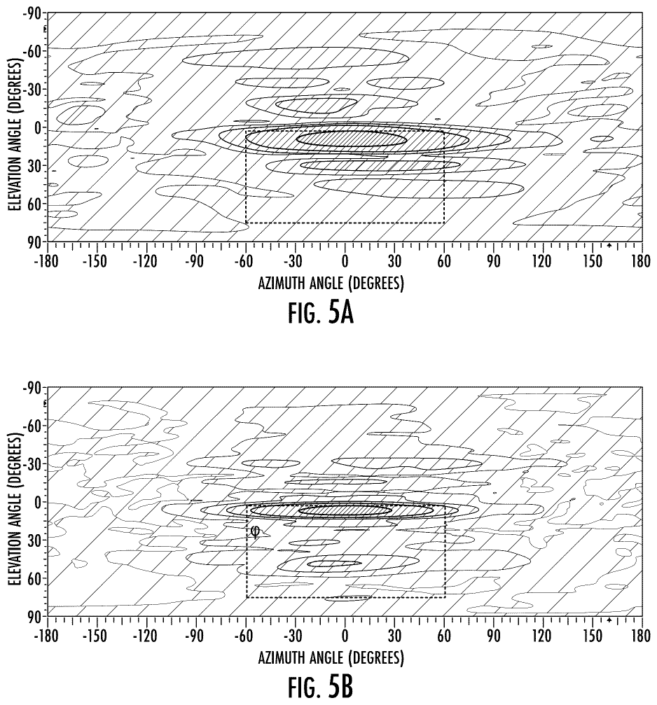

The benefits that can be provided by selectively downtilting (i.e., as a function of azimuth angle) portions of the main lobe of an antenna beam can better be understood with reference to FIG. 4, which is an enlarged view of a small portion of the cellular network of FIG. 2. FIG. 4 illustrates portions of first through fifth hexagonally-shaped sectors S1-S5 that are served by respective first through fifth base station antennas A1-A5. The first base station antenna A1 is part of a first base station, the second and third base station antennas A2, A3 are part of a second base station, and the fourth and fifth base station antennas A4, A5 are part of respective third and fourth base stations.

As shown in FIG. 4, the boresight pointing direction in the azimuth plane (and hence the direction of highest gain) for the antenna beam that is generated by a linear array in the first base station antenna A1 (the antenna beam is designated by the bold arrow labelled B1 that extends along a boresight pointing direction of the antenna beam B1) is pointed at the intersection of the second and third sectors S2, S3 of the adjacent cell. This intersection is where the antenna beams B2, B3 generated by the base station antennas A2, A3 that serve the second and third sectors S2, S3 will be perhaps 10 dB below their peak gain (since the azimuth 10 dB beamwidth for a typical three sector base station antenna may be about 120°), and hence on the surface it might appear that the SINR levels in the regions of the second and third sectors S2, S3 designated by ellipses R1 and R2 would be relatively low. However, the distance from the first base station antenna A1 to regions R1, R2 is significantly greater than it is to other regions of the second and third sectors (e.g., regions R3 and R4 in FIG. 4), and hence the power level of the portion of the first antenna beam B1 that impinges into regions R1 and R2 will be reduced by the increased free space loss associated with the greater distance (which loss increases exponentially with distance). Moreover, the distance from the second base station antenna A2 to region R1 and from the third base station antenna A3 to region R3 is relatively less due to the hexagonal shapes of the sectors. Thus, while the magnitude of the second and third antenna beams B2, B3 at the azimuth angles that subtend regions R1 and R² is reduced significantly from the peak magnitude, the free space loss experienced by the portions of the antenna beams B2, B3 providing service to the respective regions R1, R2 is less. Thus, the impact of the interference caused by the first antenna beam B1 in regions R1 and R2 may be manageable.

In contrast, Applicants have discovered that the impact of the interference caused by the first antenna beam B1 in regions R3 and R4 may be significantly higher. Region R3 is served by the fourth base station antenna A4 that provides coverage to the fourth sector S4 and region R5 is served by the fifth base station antenna A5 that provides coverage to the fifth sector S5. In particular, the interference caused by the portions of the first antenna beam B1 that extend at azimuth angles of −30° to −60 and 30° to 60° from the boresight pointing direction of antenna beam B1 (represented by cones C1 and C2 in FIG. 4) may degrade the SINR performance of users in regions R3 and R4 of sectors S4 and S5, respectively. Applicants have discovered that for these ranges of azimuth angles (and for azimuth angles outside of these ranges where the main lobe spills over into adjacent sectors), the overall performance of a cellular network may be improved if the downtilt angle of the first antenna beam B1 may be selectively increased as compared to, for example, the downtilt angle at boresight and/or as compared to the downtilt angle of antenna beam B1 that provides coverage to regions R1 and R2 (and particularly the portions of R1 and R2 that are closer to the boresight pointing direction of antenna beam B1). More generally, Applicants have discovered that the overall capacity supported by a cellular network may be increased if the antenna beams of the base station antennas are configured to have electronic downtilt angles that vary as a function of azimuth angle.

Pursuant to embodiments of the present invention, base station antennas are provided that generate antenna beams that have electronic tilt angles that vary as a function of azimuth angle (which is referred to herein as “variable electronic tilt”). These base station antennas may include parasitic structures or other elements (or techniques) that adjust the phases of the emitted RF energy to increase and/or decrease the amount of electronic downtilt applied to the emitted antenna beams as a function of azimuth pointing angle. In some embodiments, the base station antennas may be configured to increase the amount of electronic downtilt at first and second ranges of azimuth angles that are on either side of the azimuth angle corresponding to the boresight pointing direction of the antenna beam (e.g., if the azimuth angle of the boresight pointing direction is 0°, then the first range of azimuth angles would be a range of negative azimuth angles and the second range of azimuth angles would be a range of positive azimuth angles). In example embodiments, the electronic downtilt applied to the antenna beam may be increased (e.g., compared to the amount of electronic downtilt at boresight) for portions of the antenna beam at azimuth angles of −15° to −60° and for portions of the antenna beam at azimuth angles of 15° to 60°. In other embodiments, the electronic downtilt may be increased for narrower ranges of azimuth angles. In some embodiments, the extra electronic downtilt applied may be at least 1°, at least 2°, at least 3° or at least 5°.

As discussed above, the conventional view was that providing linear arrays that generated antenna beams having increased gain would act to increase the capacity of the cellular network, even though the higher gain antenna beams would increase the interference levels in neighboring sectors. Applicants have discovered that advantageously shaping the antenna beams by adjusting the amount of electronic downtilt as a function of azimuth angle can act to increase overall capacity, even though the increased electronic downtilt angles effectively reduce the gain of the antenna beam to selected portions of the sector. This improvement arises because the reduction in interference in selected portions of neighboring sectors may enhance throughput more than the loss in effective gain.

A variety of different techniques may be used to generate antenna beams that have amounts of downtilt that vary as a function of the azimuth pointing direction. In some embodiments, the linear array of radiating elements that is used to generate the antenna beam may have the radiating elements mounted at different depths within the base station antenna (so that some radiating elements are mounted farther forwardly than other of the radiating elements). In other embodiments, phase adjustment elements may be mounted forwardly of some or all of the radiating elements in the array that are used to apply different amounts of delay to RF energy emitted by different ones of the radiating elements. These phase delay elements may or may not overlap the radiating elements in the forward direction (e.g., they may be directly in front of the radiating elements or off to the sides of the radiating elements). The phase delay elements may comprise, for example, dielectric materials, metamaterials or the like. In each case, the net effect is that the phase centers of some of the radiating elements in the depth direction of the antenna are offset from the phase centers in the depth direction of others of the radiating elements, which acts to provide the above-discussed variable electronic downtilt to the generated antenna beams.

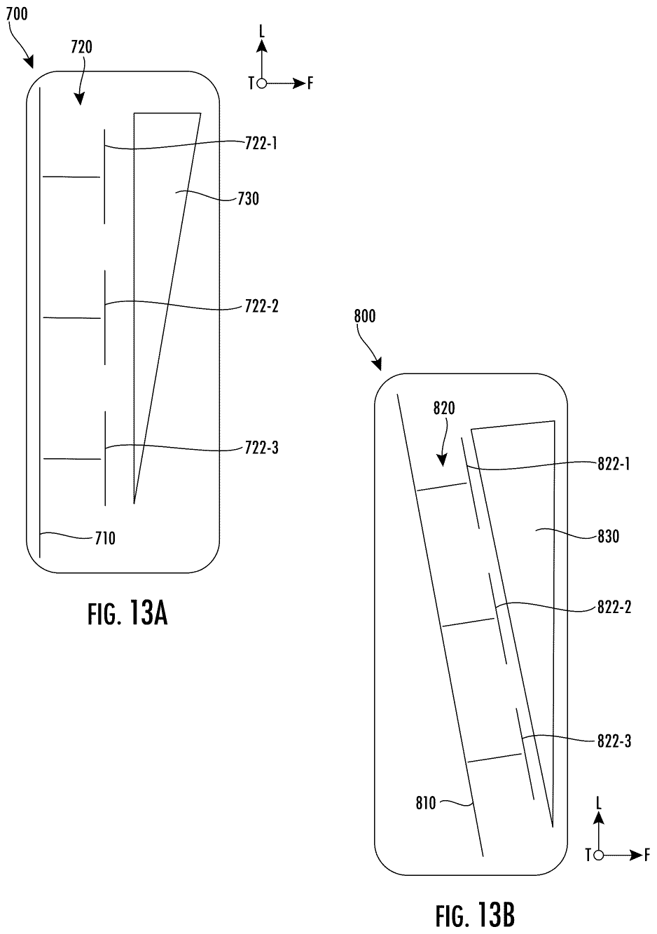

The linear array may be designed so that the radiating elements have either a phase center lag or a phase center lead. A linear array is considered to have a phase center lag if the phase centers in the depth direction of at least some of the radiating elements that are at the top of the array lag the phase centers in the depth direction of at least some of the radiating elements that are at the bottom of the array. When such a phase center lag is present, in order to ensure that the proper amount of downtilt is applied to the antenna beams generated by the linear array by a remote electronic downtilt system of the antenna, phase compensation may be applied to one or more of the radiating elements in the linear array so that all of the radiating elements have the same phase in the boresight pointing direction of the array. As will be discussed in greater detail herein with reference to FIGS. 14A-14C, as a result of this phase compensation the phase of the RF radiation emitted by the radiating elements at the top of the linear array will lead the phase of the RF radiation emitted by the radiating elements at the bottom of the linear array, which causes the generated antenna beams to be bent downwardly in the outer portions of the coverage area (i.e., at larger azimuth angles from boresight) as compared to the central region of the coverage area. A linear array is considered to have a phase center lead if the phase centers in the depth direction of at least some of the radiating elements at the top of the array have phase centers that lead the phase centers in the depth direction of at least some of the radiating elements at the bottom of the array. When such a phase center lead is present, in order to ensure that the proper amount of downtilt is applied to the antenna beams generated by the linear array by a remote electronic downtilt system of the antenna, phase compensation may be applied to one or more radiating elements in the linear array so that all of the radiating elements have the same phase in the boresight pointing direction of the array. As a result of this phase compensation the phase of the RF radiation emitted by the radiating elements at the top of the linear array will lag the phase of the RF radiation emitted by the radiating elements at the bottom of the linear array, which causes the generated antenna beams to be bent upwardly in the outer portions of the coverage area (i.e., at larger azimuth angles from boresight) as compared to the central region of the coverage area.

Configuring a linear array to have a phase lag may be advantageous at base stations where the primary concern is increased capacity, which is typically the case in urban and suburban regions. As described above, the phase lag results in higher amount of electronic downtilt to portions of the antenna beam that are at larger azimuth angles as compared to the amount of electronic downtilt that is applied at the boresight azimuth angle. The phase lag may be designed so that the central portion (e.g., the center third of the main lobe) of the antenna beam has a relatively constant amount of electronic downtilt that corresponds to the amount of any downtilt applied by a remote electronic tilt system of the linear array. In contrast, the amount of electronic downtilt applied to the outer portions (e.g., the outer thirds of the main lobe) of the antenna beam is increased as compared to the central portion due to the phase lag. This reduces the amount of RF energy that spills into adjacent sectors, improving the SINR in the adjacent sectors, which can increase the capacity of the cellular system.

Configuring a linear array to have a phase lead may be advantageous at base stations where the primary concern is coverage, which is typically the case in rural areas. As described above, the phase lead results in a lower amount of electronic downtilt being applied to portions of the antenna beam that are at larger azimuth angles as compared to the amount of electronic downtilt that is applied at the boresight azimuth angle. The phase lead may be designed so that the central portion (e.g., the center third of the main lobe) of the antenna beam has a relatively constant amount of electronic downtilt that corresponds to the amount of any downtilt applied by a remote electronic tilt system of the linear array, while the amount of electronic downtilt applied to the outer portions (e.g., the outer thirds of the main lobe) of the antenna beam may be less than the amount of electronic downtilt as compared to the central portion. This increases the amount of RF energy supplied at the outer edges of the sector, ensuring that those areas have decent coverage. In rural areas, there may be very few users so the impact of the increased interference into adjacent cells may not have a big impact on network performance.

Pursuant to still further embodiments of the present invention, base station antennas are provided that have remote variable electronic tilt systems. These remote variable electronic tilt systems are also referred to herein as “adjustable pattern control systems” to avoid confusion with conventional remote electronic tilt systems that apply a constant electronic downtilt to the antenna beams generated by an array. As discussed above, remote electronic tilt or “RET” systems are known in the art and allow a network operator to adjust, from a remote location, the tilt angle of an antenna beam (i.e., the elevation angle where the antenna beam has peak directivity). By changing the tilt angle, the size of the sector covered by the antenna beam can be changed. In contrast, a variable electronic tilt system (i.e., an adjustable pattern control system) refers to a system that allows a cellular operator to change the amount of tilt that is applied to portions of an antenna beam that are directed at azimuth angles that correspond to the edges of the coverage area for the antenna beam as compared to portions of the antenna beam that are relatively near the azimuth boresight pointing direction of the linear array. The provision of a adjustable pattern control system may allow a linear array to switch between operating as a capacity antenna and a coverage antenna. Moreover, in some embodiments, the base station antennas may have adjustable pattern control systems that allow a cellular operator to adjust the amount of variable electronic tilt that is applied to the antenna beam from a remote location.

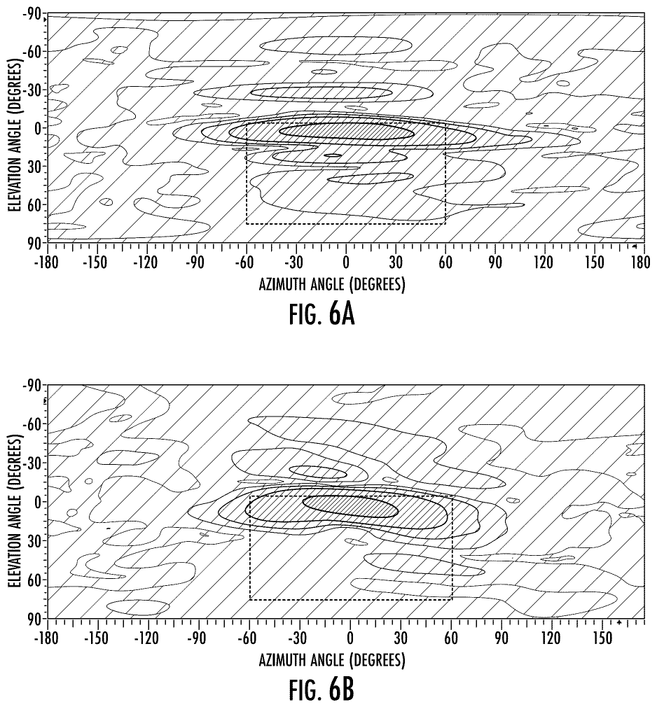

FIGS. 5A and 5B are two-dimensional graphs that illustrate the RF energy levels of antenna beams generated by conventional passive linear arrays as a function of azimuth and elevation angle. In each of FIGS. 5A and 5B, the horizontal axis represents the azimuth plane and the vertical axis represents the elevation plane, and the color at each point in the graph represents the power level of the antenna beam. Thus, FIGS. 5A and 5B show the RF power levels of the antenna beams in all directions. In FIGS. 5A and 5B, the purple and blue regions in the graphs represent directions where the antenna beam has lower power levels, the green regions represent directions where the antenna beam has moderate power levels, and the yellow regions represent directions where the antenna beam has high power levels. The horizontal regions in the middle of the two graphs that include yellow regions generally correspond to the main lobes of the respective antenna beams. As shown, the center of each main lobe has a high power level over a range of azimuth angles from about −35° to 35°. The sidelobes in the elevation plane can also be seen in FIGS. 5A and 5B as the narrow horizontal stripes of blue region in between the main lobe and two horizontally-extending green regions and in between additional horizontally-extending green regions. As can also be seen in both FIGS. 5A and 5B, the main lobe generally extents along a horizontal axis. This indicates that the generated antenna beam has the same amount of electronic downtilt (if any) as a function of azimuth angle.

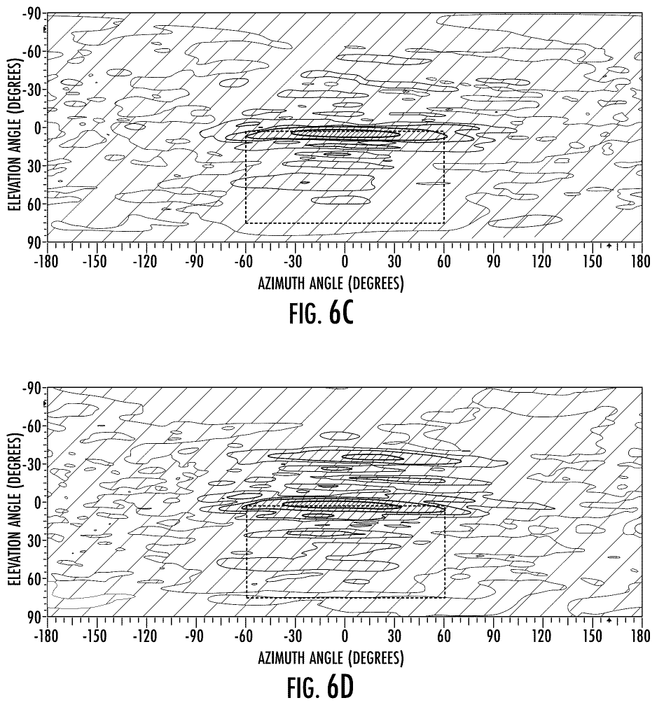

FIGS. 6A-6D are two-dimensional graphs that illustrate the RF energy levels of antenna beams generated by passive linear arrays according to embodiments of the present invention as a function of azimuth and elevation angle. The graphs of FIGS. 6A-6D are identical to the graphs of FIGS. 5A-5B except that they the antenna beams generated by base station antennas according to embodiments of the present invention that have variable electronic downtilt as a function of azimuth angle.

As can be seen in each of FIGS. 6A-6D, the main lobe of each antenna beam no longer generally extends along a horizontal axis, but instead curves gently downwardly with increasing distance from an azimuth angle of 0°. This indicates that the electronic downtilt angles of the generated antenna beams are gently increasing, generally monotonically, with an increase in the absolute value of the azimuth angle. Applicants have discovered that cellular networks that have antenna beams that exhibit such variable electronic downtilt may support higher throughputs than cellular networks that have base station antennas that generate antenna beams having a generally fixed amount of electronic downtilt as a function of azimuth angle, such as the antenna beams of FIGS. 5A-5B. Simulations suggest that significant improvement in capacity may be realized by increasing the amount of electronic downtilt at angles farther away from the boresight pointing direction (e.g., at azimuth angles having an absolute value of at least 15°, at least 30°, or at least 40°). The amount of additional electronic downtilt applied at higher azimuth angles may be selected to maximize capacity of the cellular network while maintaining adequate performance at the cell edges. While the amount of electronic downtilt may change generally monotonically with increasing deviation from the boresight azimuth angle in some cases, it will be appreciated that embodiments of the present invention are not limited thereto. For example, in other embodiments the change may not be monotonic.

As described above, an electronic downtilt may be applied to an antenna beam by applying a phase taper to the different sets of radiating elements in the linear array. For example, in a linear array that has ten radiating elements that are fed in pairs, the uppermost pair may be fed to have a relative phase of 2X°, the next to uppermost pair may be fed to have a relative phase of X°, the center pair may be fed to have a relative phase of −0°, the next to lowermost pair may be fed to have a relative phase of −X°, and the lowermost pair may be fed to have a relative phase of −2X°, where −X is a positive number. This is typically accomplished by applying the phase taper using an electromechanical phase shifter that is in the feed network for the radiating elements in the linear array. Since the phase taper is applied to the sub-components of the RF signal before they are radiated by the linear array, the phase taper will impact the antenna beam equally at all azimuth angles.

In order to apply a variable electronic downtilt to an antenna beam, parasitic elements (which are also referred to herein as “selective downtilt elements” and as “phase adjustment elements”) may be provided in an antenna that are designed to increase (or, alternatively, decrease) the amount of electronic downtilt with respect to radiation that is emitted by a linear array in selected directions in the azimuth plane. The parasitic elements may, for example, be located in front of the radiating elements and configured to apply a phase taper to RF energy that is directed over a range of azimuth angles (e.g., azimuth angles of −70° to −15° and azimuth angles of 15° to 70° or azimuth angles of −70° to −30° and azimuth angles of 30° to 70°). The amount of electronic downtilt applied may vary over the range of azimuth angles. For example, the amount of electronic downtilt applied may increase monotonically as the azimuth angles deviates from boresight (0° in the azimuth plane). Since the parasitic elements are designed to apply a phase taper, the parasitic elements at the top of the array may differ from the parasitic elements at the bottom of the array, or may be mounted in different locations and/or oriented differently (e.g., rotated 180°). It will also be appreciated that the parasitic elements need not be located in front of the radiating elements. For example, in other embodiments the parasitic elements could be mounted between the radiators of the radiating elements and a reflector of the antenna and configured to adjust the phases of backwardly directed radiation that is redirected forwardly by the reflector at azimuth angles where increased amounts of electronic downtilt are desired.

Still referring to FIGS. 6A-6D, pursuant to some embodiments of the present invention, base station antennas are provided that comprise a linear array of radiating elements that is configured to generate an antenna beam having a main lobe that has a first amount of electronic downtilt in a first pointing direction in the azimuth plane and that has a second amount of electronic downtilt in a second pointing direction in the azimuth plane, where the second amount of electronic downtilt exceeds the first amount of electronic downtilt by at least 1°, by at least 2°, by at least 3°, or by at least 5°.

In some embodiments, the first pointing direction in the azimuth plane is the boresight pointing angle of the antenna beam. In some embodiments, the second pointing direction in the azimuth plane is an azimuth angle that is between −60° and −15° or an azimuth angle that is between 15° and 60°, or an azimuth angle that is between −45° and −20° or an azimuth angle that is between 20° and 45°, or at an azimuth angle that is between −25° and −40° or an azimuth angle that is between 25° and 40°.

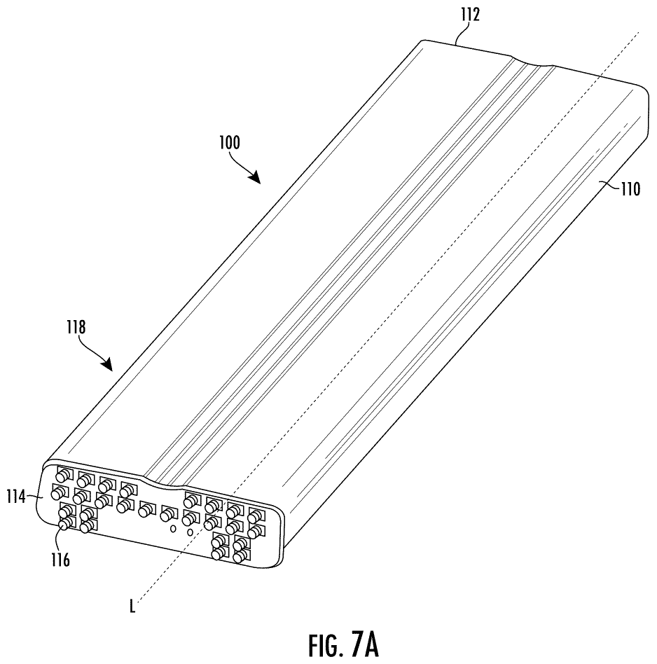

FIG. 7A is a schematic front view of a base station antenna 100 according to embodiments of the present invention. FIG. 7B is a schematic perspective view of an antenna assembly of the base station antenna 100. The base station antenna 100 has a plurality of selective downtilt elements such as parasitic elements that are configured to variably adjust the downtilt angles of the antenna beams generated by the linear arrays in the antenna 100.

As shown in FIG. 7A, the base station antenna 100 is an elongated structure that extends along a longitudinal axis L. The base station antenna 100 may have a tubular shape with a generally rectangular cross-section. The base station antenna 100 includes a tubular radome 110 and a top end cap 112. The base station antenna 100 also includes a bottom end cap 114 which includes a plurality of connectors 116 such as RF ports mounted therein. The RF ports 116 extend through the bottom end cap 114. The radome 110, top cap 112 and bottom cap 114 may form an external housing 118 for the antenna 100. An antenna assembly 120 is contained within the external housing 118. Radios that are external to base station antenna 100 may be electrically connected to the linear arrays of antenna 100 via the connectors/RF ports 116.

As shown in FIG. 7B, the antenna assembly 120 of base station antenna 100 includes a ground plane structure 122 that includes a metallic surface (e.g., a sheet of aluminium or a frequency selective surface that is reflective with respect to the linear arrays mounted in front of the frequency selective surface) that serves as a reflector 124 and ground plane for the linear arrays of radiating elements included in the base station antenna 100. Various mechanical and electronic components of the antenna (not shown) may be mounted behind the reflector 124 such as, for example, phase shifters, remote electronic tilt units, mechanical linkages, controllers, diplexers, and the like.

A plurality of linear arrays of dual-polarized radiating elements are mounted to extend forwardly from the reflector 124. The linear arrays include two linear arrays 130-1, 130-2 that each comprise a respective vertically-extending column of low-band radiating elements 132, and four linear arrays 140-1 through 140-4 that each comprise a respective vertically-extending column of mid-band radiating elements 142. The RF ports 116 are used to connect the linear arrays 130, 140 to one or more external radios (not shown). Herein, the linear arrays 130-1, 130-2 of low-band radiating elements 132 may also be referred to as the low-band linear arrays 130-1, 130-2, and the linear arrays 140-1 through 140-4 of mid-band radiating elements 142 may also be referred to as the mid-band linear arrays 140-1 through 140-4. It should be noted that herein like elements may be referred to individually by their full reference numeral (e.g., low-band linear array 130-2) and may be referred to collectively by the first part of their reference numeral (e.g., the low-band linear arrays 130).

In the depicted embodiment, the first low-band linear array 130-1 is positioned between the first and second mid-band linear arrays 140-1, 140-2, and the second low-band linear array 130-2 is positioned between the third and fourth mid-band linear arrays 140-3, 140-4. It will be appreciated that base station antenna 100 illustrates one typical layout of arrays of low-band and mid-band linear arrays 130, 140. It will likewise be appreciated that the number and/or types of arrays may be varied from what is shown based on applications and/or customer requirements, as may the positioning of the linear arrays on the reflector and/or the number of radiating elements included in each linear array.

The low-band radiating elements 132 may be configured to transmit and receive signals in a first frequency band such as, for example, the 617-960 MHz frequency range or a portion thereof (and most typically, in the 696-960 MHz frequency band). The mid-band radiating elements 142 may be configured to transmit and receive signals in a second frequency band such as, for example, the 1427-2690 MHz frequency range or a portion thereof (and most typically, the 1695-2690 MHz frequency band). The radiating elements 132, 142 may be dual polarized radiating elements (e.g., −45°/+45° cross-dipole radiating elements), and hence each linear array 130, 140 may be used to form a pair of antenna beams, namely an antenna beam for each of the two polarizations. While not shown in the drawings, the radiating elements 132, 142 may be mounted on feed board printed circuit boards that couple RF signals to and from the individual radiating elements 132, 142. One or more radiating elements 132, 142 may be mounted on each feed board printed circuit board. Cables may be used to connect each feed board printed circuit board to other components of the antenna such as diplexers, phase shifters or the like.

The above-described elements of base station antenna 100 may all be of conventional design.

As is further shown in FIG. 7B, base station antenna 100 includes a plurality of sets of parasitic elements 150. In FIG. 7B two sets 150-1, 150-2 of parasitic elements 152 are shown as an example, but it will be appreciated that any appropriate number of sets 150 of parasitic elements 152 may be provided. For example, in other embodiments, a set 150 of parasitic elements 152 may be provided for each linear array 130, 140 in base station antenna 100. Each set 150 of parasitic elements 152 may comprise a set of variable downtilt elements that are configured to apply a phase taper to RF energy that is emitted by a selected one of the linear arrays 130, 140 for a subset of the azimuth angles corresponding to the main beam of the antenna beam (or antenna beams) generated by the selected one of the linear arrays 130, 140.

Each parasitic element 152 may comprise a phase adjustment element that is configured to adjust the phase of RF signals that are incident on the parasitic element 152 and to reradiate the RF signals. In some embodiments, the parasitic elements 152 may redirect at least some of the received RF signals in one or more different directions in the azimuth plane, while in other embodiments the RF signals may pass through the parasitic elements 152 without being redirected in the azimuth plane, but with the RF signals experiencing a desired amount of phase change.

In the example of FIG. 7B, the first set 150-1 of parasitic elements 152 is associated with the first low-band linear array 130-1 and the second set 150-2 of parasitic elements 152 is associated with the second low-band linear array 130-2. Each parasitic element 152 in the first set is implemented as a “pass-through” parasitic element 152, meaning that the RF energy that impinges on the parasitic element 152 will pass therethrough without being redirected in a different direction. The parasitic elements 152 will also impart a desired amount of phase change on the RF energy passing therethrough. In an example embodiment, each parasitic element 152 may comprise, for example, a dielectric structure 152 that has a sufficient thickness and dielectric constant such that a non-negligible phase change will be imparted on RF energy that passes through the dielectric structure 152. The dielectric structures 152 may be positioned so that only selected portions of the RF signals emitted by the linear array 130-1 will pass through each dielectric structure. For example, RF energy may be emitted by the first low-band linear array 130-1 at selected azimuth angles. The portions of an RF signal emitted by the first low-band linear array 130-1 that pass through these dielectric structures 152 will exhibit a higher level of phase change than will portions of the RF signal that are not incident on the dielectric structures 152. The thickness and/or dielectric constant of the dielectric structures 152 may be varied along the length of the base station antenna 100 so that the dielectric structures 152 impart a phase taper on the RF energy emitted at selected ranges of azimuth angles. In this manner, a variable electronic downtilt may be applied to the antenna beams emitted by linear array 130-1. The second set 150-2 of dielectric structures 152 may similarly be used to impart a variable electronic downtilt on the antenna beams emitted by the second low-band linear array 150-2.

In further embodiments, base station antennas may be provided that have parasitic elements that reflect portions of the RF signals emitted by linear arrays 130-1, 130-2 in one or more different directions in the azimuth plane while also implementing a phase change on the reflected portions of the RF signals.

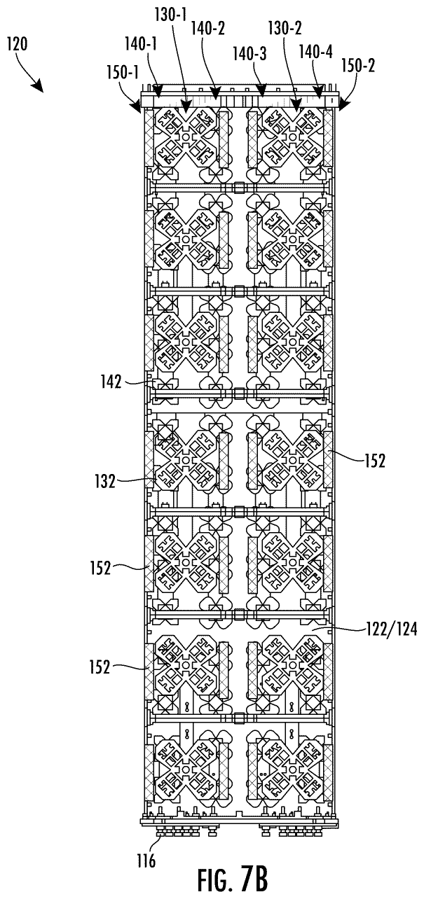

FIG. 8 is a schematic figure showing one such embodiment in which parasitic elements 252 are used to impart additional electronic downtilt to RF signals emitted by a linear array of radiating elements 230. To simplify the drawing, FIG. 8 only shows one of the radiating elements 230 in the linear array and four parasitic elements 252 that are used to adjust the phase of selected portions of the radiation emitted by the radiating element 230. It will be appreciated that additional parasitic elements 252 may be positioned adjacent other of the radiating elements 230 in the array in the same manner, with at least some of the additional parasitic elements 252 configured to impart different amounts of phase change to RF signals incident on the parasitic elements 252.

In the embodiment shown in FIG. 8, the parasitic elements 252 are implemented as passive (unpowered) intelligent reflective surfaces. A reflective intelligent surface refers to a metamaterial surface that is configured to reflect RF signals that are incident thereon, and have the capability to “steer” the reflected signals in a desired manner. A reflective intelligent surface includes a surface that comprises a large number of “unit cell” structures that can be configured to cause the reflections of incident RF signals to exit the reflective intelligent surface in desired directions. In particular, the reflective intelligent surface may steer the reflected RF energy in a desired direction by including resonant circuits in the unit cells that change the phase of the reflected RF signal in a desired fashion. A more detailed description of such reflective intelligent surfaces is provided in U.S. Provisional Patent Application No. 63/650,431, filed May 22, 2024, the entire content of which is incorporated herein by reference.

As shown in FIG. 8, a pair of reflective intelligent surface parasitic elements 252 may be positioned forwardly along each side of the radiating element 232 and configured so that RF energy emitted by the radiating element 230 over a pre-selected range of azimuth angles will be incident on the lower parasitic element 252 of each pair The RF energy that is incident on the reflective intelligent surface 252 will be reflected from the surface and the reflective intelligent surface 252 may also apply a preselected phase shift to the reflected RF signal. The second parasitic element 252 in each pair, which may comprise another reflective intelligent surface or simply a reflective surface may redirect the reflected RF signal back in its original direction, as shown by the arrows in FIG. 8. The reflective intelligent surfaces 252 associated with different of the radiating elements 230 in the linear array may be configured to apply different amounts of phase shift so that a phase taper is applied to the RF energy that is incident on and redirected by the parasitic elements 252. As discussed above, the parasitic elements 252 may be positioned so that the phase taper is only applied to RF energy that is emitted by the linear array over a preselected range of azimuth angles (e.g., azimuth angles of 15° to) 70°. The reflective intelligent surfaces 252 may be configured to apply the same amount of additional phase shift (and hence electronic downtilt) to RF energy over the range of azimuth angles or may apply different amounts of phase shift (and hence electronic downtilt) over the range of azimuth angles. For example, the amount of electronic downtilt applied may increase the more the azimuth angles deviates from boresight (0° in the azimuth plane). Since the parasitic elements 252 are designed to apply a phase taper, the parasitic elements 252 adjacent the radiating element(s) 232 at the top of the linear array may differ from the parasitic elements 252 that are adjacent radiating elements 232 at the bottom of the linear array. Alternatively or additionally, the parasitic elements 252 may be mounted in different locations adjacent different radiating elements 252 and/or oriented differently (e.g., rotated 180°) so that each parasitic element applies an appropriate amount of phase change to achieve a desired amount of electronic downtilt for RF energy emitted at a selected range of azimuth angles.

It will be appreciated that FIGS. 7A-7B and 8 illustrate two examples of ways of using parasitic elements to impart an electronic downtilt to an antenna beam that varies as a function of the azimuth angle of the antenna beam. Numerous other parasitic element designs may be used. As another example, parasitic elements may be positioned at strategic locations within the radome of the base station antenna to add additional phase shift to RF radiation that is directed over selected ranges of azimuth angles. As yet another example, parasitic elements may be provided that exhibit different amounts of inductance, where the different amounts of inductance result in different amounts of phase shift being applied to the radiating elements associated with (e.g., the receive the RF radiation from) each parasitic element.

It will also be appreciated that in other embodiments a variable electronic downtilt may be achieved by setting the remote electronic downtilt setting to apply more electronic downtilt than desired and to then use parasitic elements or other mechanisms to reduce the amount of electronic downtilt applied over a range of azimuth angles (e.g., −30° to) 30°.

The inter-sector distance refers to the distance from a first base station antenna to the closest base station antenna that is within the main lobes of the antenna beams generated by the base station antenna. For example, referring to FIG. 4, the inter-sector distance for base station antenna A1 would be the distance from base station antenna A1 to base station antennas A2 and A3. Depending on factors such as terrain, the locations of small cell antennas and the like, the inter-sector distance will differ for different base station antennas. Generally speaking, the amount of electrical downtilt applied to the antenna beams generated by a base station antenna will change with changes in inter-sector distance, with smaller inter-sector distances generally resulting in larger electronic downtilt angles.

As described above, the amount of variable electronic tilt that optimizes coverage versus the amount of variable electronic tilt that optimizes capacity is different. Moreover, the amounts of variable electronic tilt that optimize coverage and capacity may also be a function of the amount of fixed electronic tilt that is applied to the antenna beams by the remote electronic tilt system of the antenna. Thus, having the capability to adjust the amount of variable electronic tilt that is applied to the antenna beams that are generated by a base station antenna may be desirable as this (1) allows the base station antenna to be switched back and forth between optimizing coverage versus capacity and (2) allows the amount of variable electronic tilt that is applied to be optimized based on the amount of fixed electronic tilt that is being applied to the antenna beams.

Pursuant to further embodiments of the present invention, base station antennas are provided that can be configured, from a remote location, to have different amounts of variable electronic tilt applied to the antenna beams that are generated by the antenna. As a result, these base station antennas can generate antenna beams with optimized sector power ratios, good spatial efficiency, three-dimensional sector roll-off and other parameters that (1) may achieve very high signal-to-interference plus noise (“SINR”) performance when the antenna is deployed in urban areas and (2) may achieve good coverage when the antenna is deployed in rural areas. Moreover, the amount of variable electronic tilt applied to the antenna beams may be adjusted based on the amount of fixed electronic tilt applied to the antenna beams to further optimize the performance of these antennas.

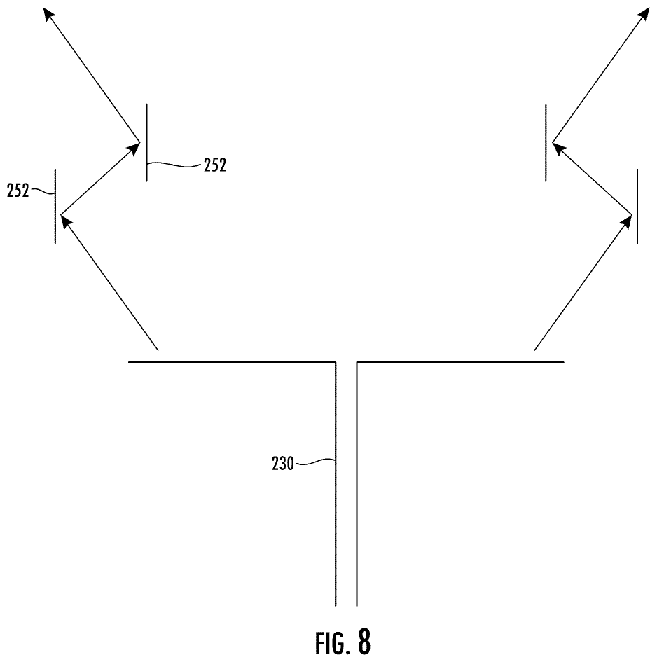

One way to provide a linear array that exhibits a variable electronic tilt (i.e., an electronic tilt that varies as a function of azimuth pointing angle) is to have some of the radiating elements of the linear array mounted rearwardly (meaning farther back in a depth direction of the antenna) than other of the radiating elements in the linear array. This can be achieved by mounting the linear array on a reflector that has a “step” in the depth direction. Including a step in the reflector causes a first portion of the linear array to have a phase center that lags the phase center of a second portion of the array (and hence the second portion of the linear array has a phase center that leads the phase center of the first portion of the linear array). Which portion of the array has a phase center lag will depend on the geometry of the linear array. This can be seen with reference to FIGS. 9A and 9B.

In particular, FIG. 9A is a schematic side view of a base station antenna 300 that illustrates how a linear array 310 of the antenna 300 can be configured to provide high signal-to-interference plus noise (“SINR”) performance. FIG. 9B is a schematic side view of another base station antenna 350 that illustrates how a linear array 360 of the antenna 350 can be configured to provide good coverage performance. The axes in FIGS. 9A-9B illustrate the longitudinal direction L, the transverse direction T and the forward direction F of base station antennas 300 and 350. The forward direction F is also referred to herein as the depth direction.

As shown in FIG. 9A, the radiating elements 312 of linear array 310 are mounted to extend forwardly from a reflector 320 that has two “steps” 322 so that the reflector 320 includes three flat sections 324-1 through 324-3 that are offset from each other in a depth direction D of the antenna 300. The first section 324-1 of the reflector 320 is mounted the farthest back in the depth direction D (i.e., closer to the rear surface of the antenna 300) while the third section 324-3 of the reflector 320 is mounted the farthest forwardly in the depth direction D. The schematic diagram included in FIG. 9A immediately in front of base station antenna 300 shows how the phase centers in the depth direction of the radiating elements 312 that are mounted on the first section 324-1 of the reflector 320 will have a phase center lag with respect to the radiating elements 312 that are mounted on the second and third sections 324-2, 324-3 of the reflector 320, and how the phase centers in the depth direction of the radiating elements 312 that are mounted on the second section 324-2 of the reflector 320 will have a phase center lag with respect to the radiating elements 312 that are mounted on the third section 324-3 of the reflector 320, and a phase center lead with respect to the radiating elements 312 that are mounted on the first section 324-1 of the reflector 320. The linear array 310 of FIG. 9A will generate antenna beams that have more electronic downtilt with respect to RF energy that is in the outer portions of the main lobe than it will have with respect to RF energy that is part of the center portion of the main lobe. Such antenna beams will have higher sector power ratios and may provide improved SINR performance as compared to antenna beams that have electronic downtilt that is generally fixed with respect to azimuth angle across the main lobe of the antenna beam. Linear arrays having the configuration shown in FIG. 9A may be well-suited for use in urban areas where network performance is driven by SINR considerations.

As shown in FIG. 9B, the radiating elements 362 of linear array 360 are mounted to extend forwardly from a reflector 370 that again has two “steps” 372 so that the reflector 370 includes three flat sections 374-1 through 374-3 that are offset from each other in a depth direction D of the antenna 350. The third section 374-3 of the reflector 370 is mounted the farthest back in the depth direction D (i.e., closer to the rear surface of the antenna 350) while the first section 374-1 of the reflector 370 is mounted the farthest forwardly in the depth direction D. The schematic diagram included in FIG. 9B immediately in front of base station antenna 350 shows how the phase centers in the depth direction of the radiating elements 362 that are mounted on the third section 374-3 of the reflector 370 will have a phase center lag with respect to the radiating elements 362 that are mounted on the first and second sections 324-1, 324-2 of the reflector 370, and how the phase centers in the depth direction of the radiating elements 362 that are mounted on the second section 374-2 of the reflector 370 will have a phase center lead with respect to the radiating elements 362 that are mounted on the third section 374-3 of the reflector 370, and a phase center lag with respect to the radiating elements 362 that are mounted on the first section 374-1 of the reflector 370. The linear array 360 of FIG. 9B will generate antenna beams that have less electronic downtilt with respect to RF energy that is in the outer portions of the main lobe than it will have with respect to RF energy that is part of the center portion of the main lobe. Such antenna beams will provide better coverage as compared to antenna beams that have electronic downtilt that is generally fixed with respect to azimuth angle across the main lobe of the antenna beam. Linear arrays having the configuration shown in FIG. 9B may be well-suited for use in rural areas where network performance is driven by coverage considerations.

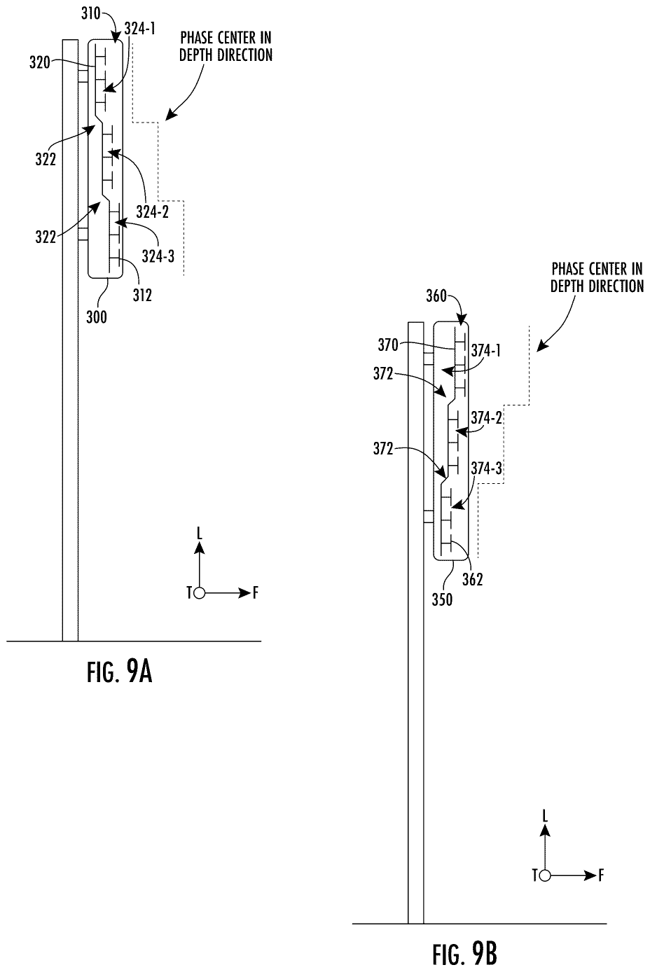

FIGS. 9A and 9B illustrate two techniques that can be used to provide a linear array that will exhibit variable electronic tilt. It will be appreciated, however, that there are a variety of different ways that linear arrays may be configured to apply variable electronic tilt to their generated antenna beams. FIGS. 10A and 10B illustrate two additional “mechanical” solutions that allow the linear arrays in a base station antenna to be configured to be optimized for capacity or coverage performance.

Referring first to FIG. 10A, a base station antenna 410 is illustrated that is mounted on an antenna tower 400 via a pair of mounting brackets 402-1, 402-2. As shown in FIG. 10A, the mounting brackets 402 are adjustable and can be set to provide a mechanical downtilt to base station antenna 410 (as shown on the left side of FIG. 10A) or to provide a mechanical uptilt to base station antenna 410 (as shown on the right side of FIG. 10A). Motors (not shown) may be provided that can be controlled from a remote location to adjust the positions of the mounting brackets 402-1, 402-2 to provide a mechanical uptilt, a mechanical downtilt, or no tilt, to base station antenna 410 as desired. Remote electronic tilt units (not shown) that are included in base station antenna 410 may be used to electronically downtilt or uptilt the antenna beams generated by base station antenna 410 so that the antenna beams have a desired tilt angle for appropriately controlling the size of the coverage area.

When base station antenna 410 is mechanically uptilted, the upper portions of the linear arrays (not shown) included in base station antenna 410 will have a phase center lead with respect to the lower portions of the linear arrays, and hence after compensating the phase center change for a certain electronic downtilt angle, the base station antenna 410 will downtilt outer portions of the main lobes of the generated antenna beams with respect to the center portions of the generated antenna beams, thereby configuring the antenna beams to have good SINR (capacity) characteristics. When base station antenna 410 is mechanically downtilted, the phase centers in the depth direction of the RF radiation emitted by the radiating elements in the upper portions of the linear arrays (not shown) included in base station antenna 410 will have a phase lag with respect to the lower portions of the linear arrays, and hence after compensating the phase center change for a certain electronic downtilt angle, the base station antenna 410 will reduce the amount of downtilt applied to outer portions of the main lobes of the generated antenna beams with respect to the center portions of the generated antenna beams, thereby configuring the antenna beams to provide good coverage performance. Thus, FIG. 10A illustrates a mechanical solution for providing variable electronic downtilt. Moreover, by motorizing the antenna brackets 402 in the manner discussed above, the antenna beams generated by base station antenna 410 can be switched between providing good coverage versus good capacity characteristics, and may also be adjusted to optimize performance based on the actual downtilt angle applied to the antenna beams by conventional RET systems included in the antenna 400.

FIG. 10B is a schematic block diagram illustrating another example technique for having a linear array generate antenna beams that have a variable electronic downtilt. Three different base station antennas 450-1 through 450-3 are shown in FIG. 10B. Base station antenna 450-1 has a conventional configuration in which the antenna includes a flat reflector 470-1 that has a longitudinal axis that extends parallel to the longitudinal axis of the antenna (and perpendicular to the transverse and depth directions of the antenna). Base station antenna 450-1 further includes a linear array of radiating elements 460-1 that extend forwardly from the reflector 470-1. Base station antenna 450-2, in contrast, has a reflector 470-2 that has a longitudinal axis that is angled so that the upper portion of the reflector extends farther forwardly than the lower section of the reflector 470-2. As such, the upper radiating elements of the linear array 460-2 that is included in base station antenna 450-2 extend farther forwardly than the lower radiating elements, and hence the phase centers in the depth direction of the RF radiation emitted by the upper radiating elements in the array 460-2 will have a phase lead as compared to phase centers in the depth direction of the RF radiation emitted by the lower radiating elements of the linear array 460-2. As a result, base station antenna 450-2 will uptilt outer portions of the main lobes of the generated antenna beams with respect to the center portions of the generated antenna beams, thereby configuring the antenna beams to have good coverage characteristics. Base station antenna 450-3 has a reflector 470-3 that has a longitudinal axis that is angled so that the lower portion of the reflector 470-3 extends farther forwardly than the upper section thereof. As such, the lower radiating elements of the linear array 460-3 that is included in base station antenna 450-3 extend farther forwardly than the upper radiating elements, and hence will have a phase lead as compared to the upper radiating elements of linear array 460-3. As a result, base station antenna 450-3 will downtilt outer portions of the main lobes of the generated antenna beams with respect to the center portions of the generated antenna beams, thereby configuring the antenna beams to have high capacity characteristics. In base station antennas 450-1 through 450-3, conventional remote electronic tilt systems may be used to apply an amount of electronic downtilt that will ensure that each antenna beam has a desired tilt angle. The amount of remote electronic tilt applied thus is adjusted to compensate for any mechanical uptilt or downtilt.

It should also be noted that the techniques illustrated in FIGS. 10A and 10B provide a progressive change in the phase centers (i.e., each radiating element in the linear array has a different phase center in the depth direction D), as opposed to the “step” changes in phase centers that are provided by the base station antennas 300, 350 of FIGS. 9A-9B. This may improve performance. As is further shown in FIG. 10B, in some embodiments, base station antenna 450-2 may include motor 470 that could pivot the reflector thereof so that the antenna could have the configuration of either base station antenna 450-2 or base station antenna 450-3 by mechanically rotating the reflector. The motor 470 could be controlled from a remote location so that such a base station antenna 450-2 could be easily reconfigured to switch between providing good coverage and good capacity.

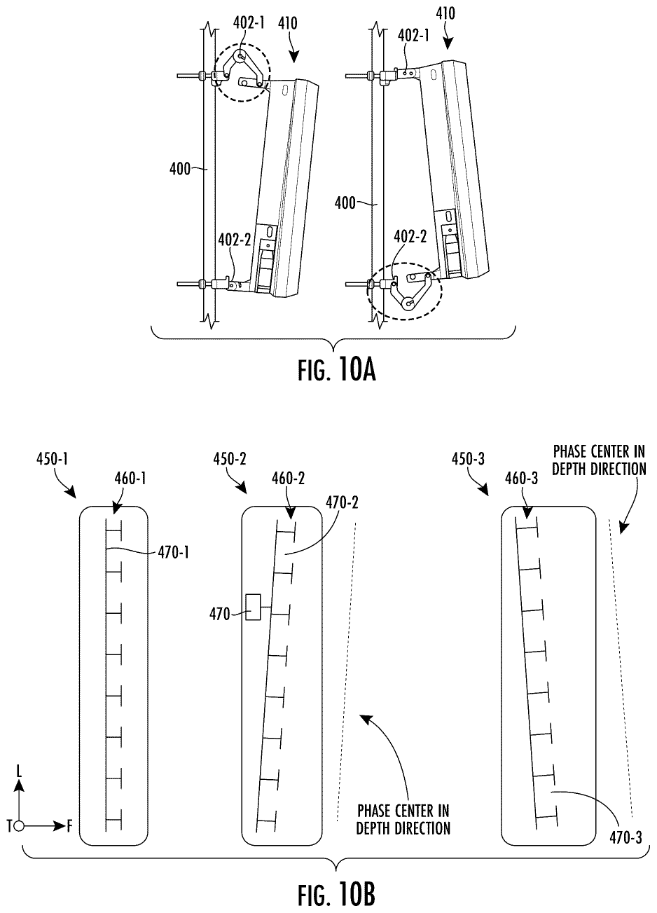

FIGS. 11A-11C are schematic front, cross-sectional and end views, respectively, of a base station antenna 500 according to further embodiments of the present invention. The base station antenna 500 includes electronically reconfigurable variable phase adjustment elements that may be used to dynamically adjust the amount of variable electronic tilt applied to the antenna beams generated by antenna 500 from a remote location. This means that a cellular network operator can easily adjust the amount of variable electronic tilt applied to switch the antenna between coverage and capacity modes, and to optimize the performance of the antenna in each mode given the desired electronic tilt applied to the antenna beams at boresight.

As shown in FIGS. 11A-11C, base station antenna 500 includes a reflector 510 that has a longitudinal axis that extends parallel to a longitudinal axis of the antenna 500 and a plurality of RF ports 540. The RF ports 540 may be connected to ports of radios (not shown) that are external to base station antenna 500. Base station antenna 500 further includes a radome 502 (which is omitted in FIG. 11A) as well as top and bottom end caps which are omitted in all three figures. The radome 502 and the top and bottom end caps form a housing for base station antenna 500. First and second linear arrays 520-1, 520-2 of low-band radiating elements 522 are mounted to extend forwardly from the reflector 510. Each low-band radiating element 522 may comprise, for example, a slant+/−45° cross-dipole radiating element, although it will be appreciated that any suitable radiating elements may be sued, and that the radiating elements may be configured to operate in any frequency band. Each radiating element 522 may include at least a first radiator 524. In the depicted embodiment, each radiating element 522 includes a first radiator 524-1 in the form of a +45° dipole radiator and a second radiator 524-2 in the form of a −45° dipole radiator. The first dipole radiator 524-1 of each radiating element 522 in the first linear array 520-1 may be connected to a first of the RF ports 540-1, and the second dipole radiator 524-2 of each radiating element 522 in the first linear array 520-1 may be connected to a second of the RF ports 540-2. The first and second dipole radiators 524-1, 524-2 of each radiating element 522 in the second linear array 520-2 may be connected in the same fashion to third and fourth of the RF ports 540-3, 540-4.

As is further shown in FIGS. 11A-11C, a respective phase adjustment element 530 is positioned in front of at least some of the radiating elements 522. Each phase adjustment element 530 may comprise a metamaterial-based phase delay surface 530. Each metamaterial-based phase delay surface 530 may comprise a unit cell based structure that is configured to impart a phase delay to RF radiation in the operating frequency band of the radiating elements 522 that passes through the metamaterial-based phase delay surface 530. Different ones of the metamaterial-based phase delay surfaces 530 may have different designs so that they impart different amounts of phase delay. The metamaterial-based phase delay surfaces 530 that are positioned in front of the radiating elements 522 of each linear array 520 may thus be used to cause the RF radiation emitted by various of the radiating elements 522 in each array 520 to either phase lag or phase lead the RF radiation emitted by various other of the radiating elements 522 in each array 520.

In some embodiments, the metamaterial-based phase delay surfaces 530 that are positioned in front of the radiating elements 522 of linear array 520-1 may be designed to impart an increasing amount of phase delay the closer the metamaterial-based phase delay surfaces 530 are the top of the linear array 520-1. As such, the metamaterial-based phase delay surfaces 530 will have a phase center profile similar to that shown in the base station antenna 450-3 of FIG. 10B. In some embodiments, the metamaterial-based phase delay surfaces 530 may be implemented using reflective intelligent surfaces. Reflective intelligent surfaces are known in the art, and can be used to adjust the phase of the TE mode RF signals that are incident on the reflective intelligent surface. Moreover, as disclosed in U.S. Provisional Patent Application Ser. No. 63/650,431, filed May 22, 2024, the entire content of which is incorporated herein by reference, reflective intelligent surfaces may also be designed that adjust the phase of the TM mode of incident signals, so that phases of both the horizontal and vertical components of incident RF signals may be adjusted.

Passive reflective intelligent surfaces are unpowered metamaterial structures that have a unit cell design. The unit cells may include one or more resonant circuits and are often implemented in a printed circuit board. The resonances in the unit cells may be adjusted by changing the metal patterns of the unit cells (e.g., to change inductive and/or capacitive couplings within the unit cells) to achieve a desired amount of phase delay. Typically, reflective intelligent surfaces have a frequency dependent response. For example, a reflective intelligent surface may be configured to change the phases of RF signals that are incident thereto in a first frequency band (such as an operating frequency band of a first array of radiating element in a base station antenna) while being substantially transparent to RF signals that are incident thereto in a second frequency band (such as an operating frequency band of a second array of radiating element in a base station antenna). Thus, by changing the unit cell design of the metamaterial-based phase delay surfaces 530 that are positioned in front of different radiating elements 522 of a linear array 520, a progressive phase lag (or phase lead) may be imparted on the RF radiation emitted by the radiating elements 522 of the linear array 520.

Reflective intelligent surfaces may be passive or active devices. Passive reflective intelligent surfaces are unpowered metamaterial structures that have a constant (i.e., unchanging) response. Active reflective intelligent surfaces refer to reflective intelligent surfaces that include powered circuit elements that may be controlled to adjust the amount of phase delay imparted by each metamaterial-based phase delay surface 530. For example, varactors, diodes, transistors, liquid crystal polymers, microelectromechanical (MEM) systems or other active (powered) components may be included in some or all of the unit cells of an active metamaterial-based phase delay surface 530 that allow the reactance (e.g., capacitance and/or inductance) of the unit cells to be changed, which in turn changes the phase delays imparted to the incident RF signals. When such “reconfigurable” metamaterial-based phase delay surfaces 530 are employed, the arrays 520 may be configured to operate as either “capacity” or “coverage” antennas by changing whether or not a phase lag or a phase lead is applied to the radiating elements 522 of the array. Herein, a linear array is considered to have a “phase lead” if the phases of the RF signals emitted by the radiating elements at the top of the array (when the base station antenna that includes the array is mounted for normal use) have phases that lead the phases of the RF signals emitted by the radiating elements at the bottom of the array. Similarly, a linear array is considered to have a “phase lag” if the phases of the RF signals emitted by the radiating elements at the top of the array (when the base station antenna that includes the array is mounted for normal use) have phases that lag the phases of the RF signals emitted by the radiating elements at the bottom of the array. As noted above, the phase lead or phase lag may be progressive, where it changes on a radiating element-by-radiating element basis, or may be a step function where groups of adjacent radiating elements emit RF energy without any phase lead or lag, but the different groups of radiating elements exhibit a phase lead or lag.

When reconfigurable (i.e., active) metamaterial-based phase delay surfaces 530 are provided, the shapes of the antenna beams generated by linear arrays 520-1, 520-2 may be changed. In some embodiments, base station antenna 500 may include an adjustable pattern control system 550 that may be used to reconfigure the metamaterial-based phase delay surfaces 530 so that a cellular operator can change the amount of variable electronic tilt that is applied to the generated antenna beams from a remote location. This allows a cellular operator to, for example, switch the linear arrays 520-1, 520-2 of base station antenna 500 between operating as coverage or capacity antennas.

Reconfigurable (i.e., active) metamaterial-based phase delay surfaces 530 may include a controller that is electrically connected to the unit cells via control lines. The controller is configured to provide control signals to the active components in the unit cells that allow the reflective intelligent surface to be reconfigured to have different responses by changing the reactance of the unit cells so that each metamaterial-based phase delay surface 530 provides a desired amount of phase change. By reconfiguring the responses of the unit cells, the linear array may be switched from operating as a capacity array (where the metamaterial-based phase delay surfaces 530 impart additional electronic downtilt to the RF energy that forms the outer portions of the main lobe of the antenna beam generated by the array as compared to the amount of electronic downtilt imparted to the RF energy that forms the central portion of the main lobe) or as a coverage array (where the metamaterial-based phase delay surfaces 530 impart less electronic downtilt to the RF radiating corresponding to the RF energy that forms the outer portions of the main lobe of the antenna beam generated by the array as compared to the amount of electronic downtilt imparted to the RF energy that forms the central portion of the main lobe). In addition, the active components may be adjusted to fine tune the shape of the antenna beam to account for the amount of remote electronic downtilt applied to the generated antenna beam.

In still other embodiments, the phase centers in the depth direction of the radiating elements 522 in the arrays 520 may be changed by physically moving the metamaterial-based phase delay surfaces 530. For example, some or all of the metamaterial-based phase delay surfaces 530 may be moved in the depth direction and or the transverse direction of base station antenna 500 to change the amount of phase lag or phase lead imparted to the RF radiation emitted by each radiating element 522. In still other embodiments, some or all of the metamaterial-based phase delay surfaces 530 may be moved in the longitudinal direction of base station antenna 500 or rotated to change the amount of phase lag or phase lead imparted to the RF radiation emitted by each radiating element 522. Multiple of the above-described techniques for changing the phase centers in the depth direction of the radiating elements 522 in the arrays 520 may be employed in some embodiments.

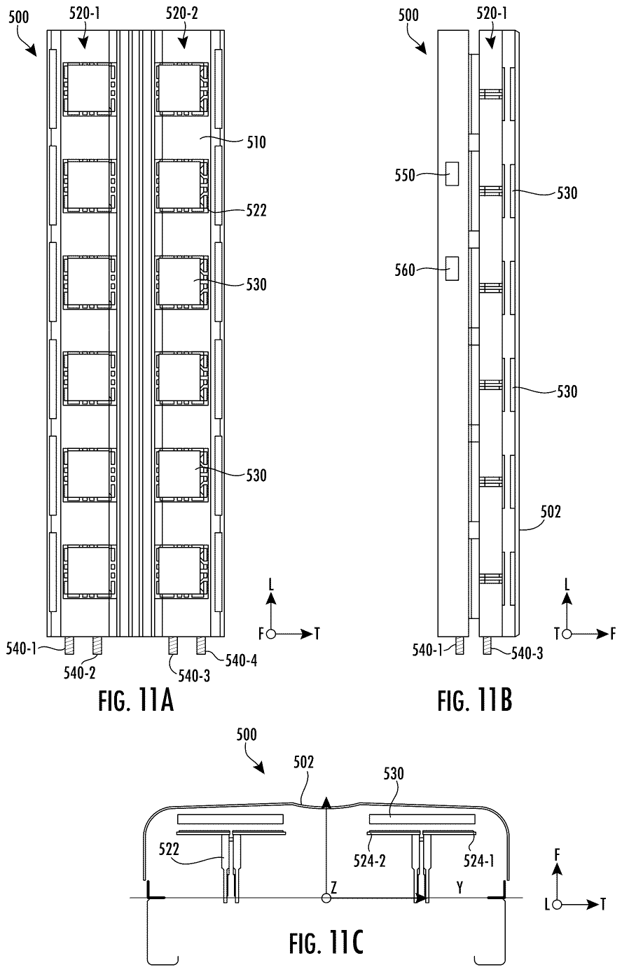

FIG. 12 is a schematic front view of a base station antenna 600 according to still further embodiments of the present invention that includes moveable phase adjustment elements 630. As shown in FIG. 12, base station antenna 600 includes a reflector 610 and first and second RF ports 640-1, 640-2. Base station antenna 600 further comprises a linear array 620 of radiating elements 622, where each radiating element 622 extends forwardly from the reflector 610. Each radiating element 622 may include at least a first radiator 624. In the depicted embodiment, each radiating element 622 includes a first radiator 624-1 in the form of a +45° dipole radiator and a second radiator 624-2 in the form of a −45° dipole radiator. The first dipole radiator 624-1 of each radiating element 622 in linear array 620 may be connected to a first RF port 640-1, and the second dipole radiator 624-2 of each radiating element 622 in the linear array 620 may be connected to the second RF port 640-2.

Base station antenna further includes a plurality of moveable phase delay elements 630. In the depicted embodiment, one or more moveable phase delay elements 630 are provided for each radiating element 622 in the array 620. The moveable phase delay elements 630 may be positioned forwardly of the radiating elements and may or may not overlap the radiating elements 622 in the depth direction (which is also the forward direction). Base station antenna 600 further includes an adjustable pattern control system 650 that may be used to change the physical positions of the moveable phase delay elements 630 so that a cellular operator can change the amount of variable electronic tilt that is applied to the antenna beams generated by linear array 620 from a remote location. Base station antenna 600 may be similar to base station antenna 100 of FIGS. 7A-7B, with the moveable phase delay elements 630 corresponding to the parasitic elements 152 of base station antenna 100. However, one difference is that in base station antenna 600, at least some of the phase delay elements 630 are moveable, which allows base station antenna 600 to, for example, be switched to operate as either a coverage or a capacity antenna, and which also allows the amount of phase center lead/lag applied to the RF radiation emitted by each radiating element 622 in linear array 620 to be adjusted, for example, to optimize the patterns for a given amount of remote electronic downtilt that is applied to linear array 620.

In some embodiments, the moveable phase delay elements 630 may be mounted on mechanical linkages that are driven by motors included in the base station antenna 600. The motors can be controlled by sending control signals to the base station antenna 600 in a manner well understood by those of skill in the art, as such remotely controlled motors that drive mechanical linkages are also routinely included in base station antennas to implement remote electronic downtilt capabilities. In some embodiments, the moveable phase delay elements 630 may be mounted on the same mechanical linkages that are used for the remote electronic tilt system so that the positions of the phase delay elements 630 are automatically adjusted each time the amount of remote electronic downtilt is adjusted. A suitable system for accomplishing this is disclosed in U.S. patent application Ser. No. 18/874,045, filed Dec. 11, 2024, the entire content of which is incorporated herein by reference.

As shown in FIG. 12, moveable phase delay elements 630 are mounted adjacent the four radiating elements 622 that make up an upper portion of the linear array 620. Each moveable phase delay elements 630 is configured for lateral movement (i.e., in the transverse direction) so that the moveable phase delay elements 630 may be moved closer to or farther away from their associated radiating elements 622. In addition, fixed (i.e., non-moveable) phase delay elements 632 are mounted in front of the three radiating elements 622 that make up the lower portion of the linear array 620. In this embodiment, the fixed delay elements 632 are mounted directly in front of their associated radiating elements 622. The fixed delay elements 632 may be configured, for example, to impart a phase lag to the RF radiation emitted by the lower three radiating elements 622 in linear array 620, while the moveable phase delay elements 630 may be configured to impart a phase lead to the RF radiation emitted by the upper four radiating elements 622 in linear array 620.

The moveable phase delay elements 630 and/or the fixed phase delay elements 640 may comprise metamaterial-based phase delay surfaces such as the metamaterial-based phase delay surfaces 530 discussed above with reference to base station antenna 500.

FIGS. 11A-11C and 12 are directed to base station antennas 500, 600 that may include an adjustable pattern control system 550, 650 that may be used, for example, to allow the antennas 500, 600 to be switched between coverage and capacity modes of operation. In each case, the base station antenna 500, 600 includes a first RF port 540-1, 640-1 and an antenna array 520, 620 that includes a plurality of radiating elements 522, 622, where each radiating element 522, 622 includes a first polarization radiator 524-1, 624-1. The first polarization radiator 524-1, 624-1 of each radiating element 522, 622 in the antenna array 520, 620 is coupled to the first RF port 540-1, 640-1. The adjustable pattern control system 550, 650 that is included in each antenna 500, 600 may be configured to adjust an average amount of electronic downtilt applied to a first outer portion of a main lobe of an antenna beam that is generated in response to an RF signal input at the first RF port 540-1, 640-1 relative to an average amount of electronic downtilt applied to a central portion of the main lobe, where the first outer portion of the main lobe comprises a first portion of the main lobe that is directed at a first range of azimuth angles and the central portion of the main lobe comprises a second portion of the main lobe that is directed at a second range of azimuth angles that do not overlap with the first range of azimuth angles and that are closer to an azimuth angle of the boresight pointing direction of the antenna beam than the azimuth angles in the first range of azimuth angles. The adjustable pattern control system 550, 650 may also be configured to adjust an average amount of electronic downtilt applied to a second outer portion of the main lobe relative to the average amount of electronic downtilt applied to the central portion of the main lobe, where the second outer portion of the main lobe comprises a third portion of the main lobe that is directed at a third range of azimuth angles that do not overlap with the second range of azimuth angles. The second range of azimuth angles is in between the first and third ranges of azimuth angles. The antenna beam may, for example, be configured to provide coverage to a 120° sector in the azimuth plane of a cell of a cellular network.

In some embodiments, the second range of azimuth angles may comprise azimuth angles that are less than 30° from the azimuth angle of the boresight pointing direction of the antenna beam, the first range of azimuth angles comprises azimuth angles that are between −30° and −60° of the azimuth angle of the boresight pointing direction of the antenna beam, and the third range of azimuth angles comprises azimuth angles that are between 30° and 60° of the azimuth angle of the boresight pointing direction of the antenna beam. Referring to FIG. 4, and assuming that the base station antenna is base station antenna A1 in FIG. 4, in such embodiments, the first range of azimuth angles will correspond to the cone-shaped region C1, the third range of azimuth angles will correspond to the cone-shaped region C2, and the second range of azimuth angles will correspond to the region in between the first and second cone-shaped regions C1, C2.

In other embodiments, the first outer portion, the second outer portion and the central portion of the antenna beam each encompass one third of the azimuth angles covered by the main lobe. In such embodiments, the first outer portion will typically roughly correspond to the cone-shaped region C1 in FIG. 4 as well as portions of the sectors that are adjacent to the cone-shaped region C1 (since the main lobe of the antenna beam typically subtends about 140° in the azimuth plane), the second outer portion will typically roughly correspond to the cone-shaped region C2 in FIG. 4 as well as portions of the sectors that are adjacent to the cone-shaped region C2, and the central portion will typically roughly correspond to the region in between the first and second cone-shaped regions C1, C2 in FIG. 4. In the above discussed embodiments, the adjustable pattern control system 550, 650 may, for example, apply, on average, at least 1°, at least 2°, at least 3° or at least 5° more electronic downtilt to the first and/or second outer portions of the main lobe than the amount of electronic downtilt that is applied, on average, to the central portion of the main lobe.

In some embodiments, the adjustable pattern control system 550, 650 is configured to apply at least 1° more electronic downtilt, on average, to the first outer portion of the main lobe than is applied, on average, to the central portion of the main lobe. In other embodiments, the adjustable pattern control system may be configured to apply at least 2°, at least 3°, at least 4°, or at least 5°, more electronic downtilt, on average, to the first outer portion of the main lobe than is applied, on average, to the central portion of the main lobe.

In some embodiments, the base station antenna 500, 600 may further comprise a remote electronic tilt system 560, 660 that is configured to adjust the boresight pointing direction of the antenna beam in the elevation plane in response to control signals received from a remote location. The adjustable pattern control system 550, 650 may be configured to adjust the amount of electronic tilt that is applied, where the adjustment in the amount of tilt changes as a function of the azimuth angle.

The base station antennas 500, 600 each include a respective reflector 510, 610. Each reflector 510, 610 extends in a longitudinal direction of its respective base station antenna 500, 600, and the radiating elements 522, 622 extend forwardly from the respective reflectors 510, 610 in a depth direction of the respective antennas 500, 600 that is perpendicular to the longitudinal direction.

The adjustable pattern control systems 550, 650 of base station antennas 500 and 600 each include a respective a plurality of phase delay elements 530, 630, 632 that are configured to adjust phase centers in the depth direction of RF energy emitted by at least some of the radiating elements 522, 622 of the antenna array 520, 620. At least some of the phase delay elements 530, 630, 632 may comprise, for example, physically moveable phase delay elements 630 and/or electronically adjustable phase delay elements 530.

Still referring to FIGS. 11A-11C and 12, pursuant to further embodiments of the present invention, base station antennas 500, 600 are provided that comprise a reflector 510, 610 that extends in a longitudinal direction of the base station antenna 500, 600, a first RF port 540-1, 640-1, an antenna array 520, 620 that includes a plurality of radiating elements 522, 622 that extend forwardly from the reflector 510, 610 in a depth direction of the base station antenna 500, 600, where the depth direction is perpendicular to the longitudinal direction. Each radiating element 522, 622 comprises a first polarization radiator 524-1, 624-1 that is coupled to the first RF port 540-1, 640-1, and a plurality of phase adjustment elements 530, 630, 632 that are configured to selectively adjust phase centers, in the depth direction, of RF energy emitted by at least some of the respective radiating elements 522, 622 in the antenna array 520, 620.

The phase adjustment elements 530, 630, 632 are positioned forwardly of the reflector 510, 610 and may comprise metamaterial phase adjustment elements or dielectric phase adjustment elements in example embodiments. In some embodiments, at least a sub-set of the phase adjustment elements 530, 630 may be physically moveable (e.g., using a motor and mechanical linkage) and/or may be configured to impart phase delays that are electrically adjustable.

In some embodiments, the phase adjustment elements 530, 630, 632 in a first sub-set of the plurality of phase adjustment elements 530, 630, 632 are configured to apply a phase lead to RF energy emitted by at least some of the radiating elements 522, 622 in an upper portion of the antenna array 520, 620 as compared to RF energy emitted by at least some of the radiating elements 522, 622 in a lower portion of the antenna array 520, 620. In other embodiments, the phase adjustment elements 530, 630, 632 in a first sub-set of the plurality of phase adjustment elements are configured to apply a phase lag to RF energy emitted by at least some of the radiating elements 522, 622 in an upper portion of the antenna array 520, 620 as compared to RF energy emitted by at least some of the radiating elements 522, 622 in a lower portion of the antenna array 520, 620.

Still referring to FIGS. 11A-11C and 12, pursuant to further embodiments of the present invention, base station antennas 500, 600 are provided that comprise a reflector 510, 610 that extends in a longitudinal direction of the base station antenna 500, 600, a first RF port 540-1, 640-1, an antenna array 520, 620 that includes a plurality of radiating elements 522, 622 that extend forwardly from the reflector 510, 610 in a depth direction of the base station antenna 500, 600 that is perpendicular to the longitudinal direction, each radiating element 522, 622 including a first polarization radiator 524-1, 624-1 that is coupled to the first RF port 540-1, 640-1, and at least first and second configurable phase adjustment elements 530, 630 that are mounted forwardly of respective first and second of the radiating elements 522, 622 in the antenna array 520, 620.

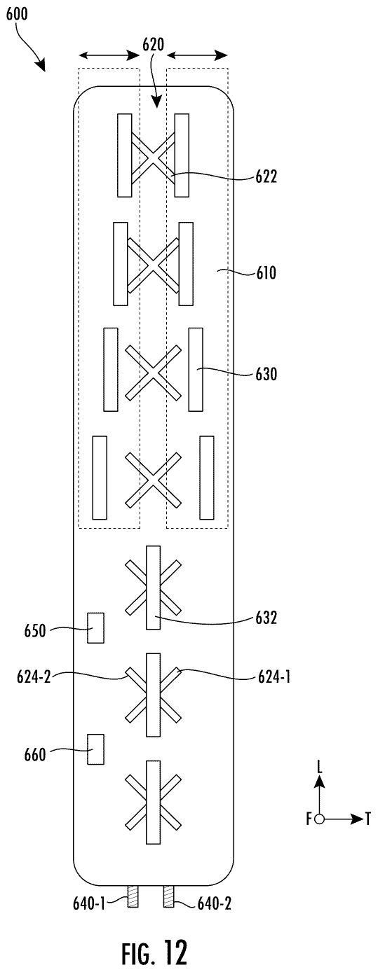

FIGS. 13A and 13B are schematic side views of base station antennas 700, 800 according to additional embodiments of the present invention that include dielectric phase adjustment elements.

As shown in FIG. 13A, base station antenna 700 includes a reflector 710 and a linear array 720 of radiating elements 722, where each radiating element 722 extends forwardly from the reflector 710. Base station antenna 700 further includes a fixed dielectric phase adjustment element 730. The amount that the phase of an RF signal changes when travelling through a dielectric material having a given thickness depends on the dielectric constant of the dielectric material, with the amount of phase change increasing with increasing dielectric constant. Thus, the phase center in the depth direction of the upper radiating element 722-1 in linear array 720 will have a phase lag with respect to the phase centers in the depth direction of the other two radiating elements 722-2, 722-3, and the phase center in the depth direction of the middle radiating element 722-2 will have a phase lag with respect to the phase center in the depth direction of radiating element 722-3, and will have a phase lead with respect to the phase center in the depth direction of radiating element 722-1 due the variable thickness of the dielectric phase adjustment element 730. While FIG. 13A shows the dielectric phase adjustment element 730 having a constantly changing thickness along the longitudinal direction of the antenna, it will be appreciated that in other embodiments the dielectric phase adjustment element could have a different configuration (e.g., a stepped configuration).

As shown in FIG. 13B, base station antenna 800 includes a reflector 810 and a linear array 820 of radiating elements 822, where each radiating element 822 extends forwardly from the reflector 810. Base station antenna 800 further includes a fixed dielectric phase adjustment element 830 that may be identical to the fixed dielectric phase adjustment element 830 of base station antenna 700. Base station antenna 800 differs from base station antenna 700 in that linear array 820 is configured to have a mechanical uptilt similar to the linear array 460-3 of base station antenna 450-3 of FIG. 10B. Thus, it will be appreciated that base station antenna 800 combines the techniques for adjusting the phase centers in the depth direction of the RF radiation emitted by the radiating element of a linear array that are disclosed with respect to base station antennas 450-3 and 700. It will be appreciated that any of the techniques disclosed herein for adjusting the phase centers in the depth direction of the RF radiation emitted by the radiating element of a linear array may be combined to provide many additional embodiments.

FIGS. 14A-14C together illustrate how the combined phase centers of the sets of radiating elements 312 that are on the different steps of the reflector 320 of the base station antenna 300 of FIG. 9A differ due to the steps in the reflector 320. In particular, FIG. 14A is a schematic side view of a base station antenna 300 that has a linear array 310 of radiating elements 312. The radiating elements 312 are mounted on a reflector 320 that has three steps 324-1, 324-2, 324-3 so that the three sub-sets of radiating elements 312 are at different positions in the depth direction of the antenna 300. As shown in FIG. 14A, the wavefront of an antenna beam that is generated by the linear array 310 of base station antenna 300 is tilted downwardly in the elevation plane.

FIG. 14B is a graph that illustrates the phase, as a function of pointing direction in the azimuth plane, of the RF radiation emitted by two of the radiating elements 312 of linear array 310. In particular, curve 330 illustrates the phase of radiating element 312-1 (which is one of the lower three radiating elements in linear array 310), while curve 332 illustrates the phase of radiating element 312-2 (which is one of the upper three radiating elements in linear array 310). As shown in FIG. 14B, in the boresight pointing direction (i.e., an azimuth angle of 0°), the phase of radiating element 312-2 lags the phase of radiating element 312-1 since radiating element 312-2 is mounted farther back in the depth direction of antenna 300. As discussed above, most base station antennas include remote electronic downtilt capabilities so that a cellular operator can adjust the amount of electronic downtilt that is applied to the antenna beams generated by a linear array in order to adjust the size of the area served by the antenna beam. In order for the “normal” remote electronic downtilt systems to operate properly, the phase lag that is shown in FIG. 14B is compensated for so that the phases of all of the radiating elements 312 are the same at boresight. This can be accomplished, for example, by shortening the transmission lines (e.g., cables) that are used to feed the radiating elements that are mounted on step 324-1 of reflector 320 or by lengthening the transmission lines that are used to feed the radiating elements that are mounted on step 324-3 of reflector 320. Adjustments would also be made with respect to the radiating elements that are mounted on step 324-2.

FIG. 14C is a graph that shows the phases of the three subarrays of radiating elements 312 on the different steps 324-1 through 324-3 of the reflector 320 as a function of azimuth angle off boresight (i.e., FIG. 14C shows the phases of the three sub-arrays 324 over the coverage area). In particular, each curve in FIG. 14C represents the phase as a function of azimuth angle of the radiating elements in a respective one of the sub-arrays 324. The phases in the first and second sub-arrays 324-1, 324-2 are normalized to the phases in the third sub-array 324-3. As shown, the phases of the radiating elements 312 that are mounted on step 324-1 shows a greater variation as a function of the azimuth angle than the radiating elements 312 on steps 324-2 and 324-3, and the radiating elements 312 that are mounted on step 324-2 show a greater variation as a function of the azimuth angle than the radiating elements 312 on step 324-3. The net effect of this phase variation is to impart a variable electronic downtilt on the generated antenna beam, where the amount of downtilt increases as the azimuth angle moves away from the boresight angle in the azimuth plane.

As the discussion of FIGS. 14A-14C above makes clear, certain embodiments of the present invention provide methods of configuring a base station antenna so that it may, for example, exhibit improved capacity or coverage performance. The base station antenna may include a reflector that extends in a longitudinal direction of the base station antenna and an antenna array that includes a plurality of radiating elements that extend forwardly from the reflector and that are spaced apart from each other in the longitudinal direction of the base station antenna. Pursuant to these methods, a base station antenna such as base station antenna 300 of FIG. 14C may be configured so that first RF radiation exiting the base station antenna 300 that is emitted by a first of the radiating elements (e.g., radiating element 312-2 that is in an upper portion of the antenna array 310 of FIG. 14A) in a broadside pointing direction of the antenna array (the broadside pointing direction of an array is the pointing direction where the antenna beams generated by the array would have peak gain if no beamforming or tilting is applied, which corresponds to an azimuth angle of 0° in FIG. 14B) has a phase offset with respect second RF radiation exiting the base station antenna 300 that is emitted by a second of the radiating elements (e.g., radiating element 312-1 that is in a lower upper portion of the antenna array 310 of FIG. 14A) in the broadside pointing direction of the antenna array. This phase offset can be seen in FIG. 14B above in the fact that curves 330 and 332 have different values at an azimuth angle of 0°. In order to compensate for this phase offset, which may be necessary so that a remote electronic downtilt system of the base station antenna 300 operates properly, a feed network (not shown) for the antenna array 310 may be configured to reduce the amount of the phase offset between the first and second RF radiation that exits the base station antenna in the broadside pointing direction of the antenna array 310. For example, the transmission lines feeding the first and second of the radiating elements may be adjusted so that the phase offset in the broadside pointing direction of the antenna array 310 is reduced or eliminated.

Pursuant to further embodiments of the present invention, base station antennas are provided such as base station antenna 300 of FIG. 14A that comprise an antenna array 310 that includes a plurality of radiating elements 312 that are spaced apart from each other in a longitudinal direction (the vertical direction in FIG. 14A), the antenna array 310 configured to generate antenna beams that provide coverage to a sector (e.g., sector S1 in FIG. 4) of a cellular communications system. The antenna array 310 may be configured so that a first phase of first RF radiation emitted by a first subset of the radiating elements 312 (e.g., the top three radiating elements 312) in an upper portion of the antenna array 310 toward a center of the sector is equal to a second phase of second RF radiation emitted by a second subset of the radiating elements 312 (e.g., the bottom three radiating elements 312) in a lower portion of the antenna array 310 toward the center of the sector. FIG. 14C illustrates how this may be the case, as it shows how the three sub-arrays of three radiating elements 312 each that are mounted on the respective three steps 324-1 through 324-3 of the reflector 320 have the same phase at an azimuth angle of 0°, which is the azimuth angle corresponding to the center of the sector. The antenna array 310 may also be configured so that a third phase of third RF radiation emitted by the first subset of the radiating elements 312 toward a first edge of the sector differs from a fourth phase of fourth RF radiation emitted by the second subset of the radiating elements 312 toward the first edge of the sector. FIG. 14C also illustrates how this may be the case, as it shows how the three sub-arrays of radiating elements 312 that are mounted on the respective three steps 324-1 through 324-3 of the reflector 320 have significantly different phases (e.g., more than 5°) at an azimuth angle of −60°, which is the azimuth angle corresponding to a first edge of the sector. The same effect is seen at the opposite edge of the sector (i.e., at an azimuth angle of) 60°.

Pursuant to still further embodiments of the present invention, base station antennas are provided that comprise a reflector that extends in a longitudinal direction of the base station antenna, an antenna array that includes a plurality of radiating elements that extend forwardly from the reflector, where the radiating elements are spaced apart from each other in the longitudinal direction of the base station antenna, and a phase adjustment system. The phase adjustment system is configured to vary an amount of phase lag or phase lead that is present between RF radiation emitted by a first subset of one or more of the radiating elements and a second subset of one or more of the radiating elements. The phase adjustment system may comprise, for example, parasitic elements that are used to adjust the phases of RF radiation emitted by some or all of the radiating elements in the array.

While the techniques of the present inventio have been described above primarily with respect to sectors that cover 120° in the azimuth plane, it will be appreciated that the exact same variable electronic tilt techniques can be applied with respect to sectors that have other sizes, such as sectors that cover 90° in the azimuth plane.

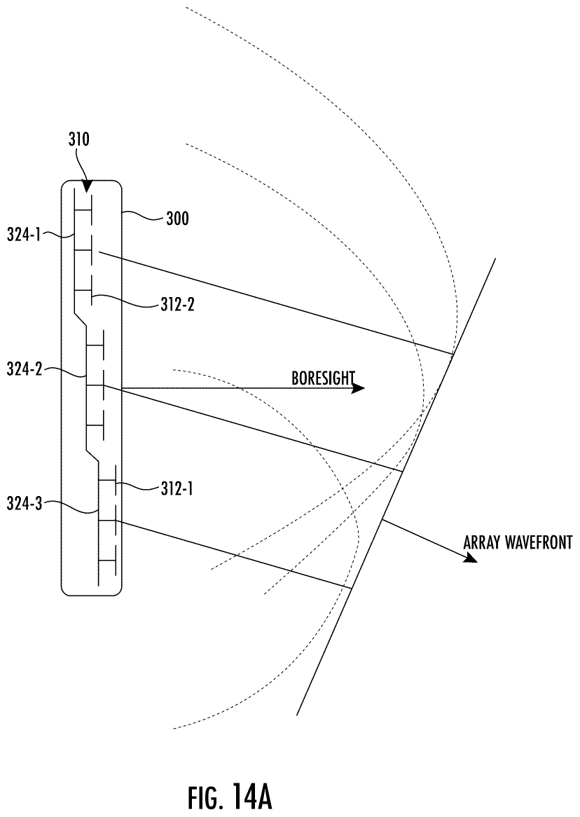

FIG. 15 is a flow chart that illustrates a method of operating a base station antenna according to certain embodiments of the present invention. The base station antenna may comprise an antenna array that includes a plurality of radiating elements that extend forwardly from a reflector in a depth direction of the base station antenna. As shown in FIG. 15, the method may comprise using a plurality of phase adjustment elements that are mounted forwardly of at least some of the radiating elements to adjust the phase centers in the depth direction of sub-components of an RF signal that are emitted by respective ones of the at least some of the radiating elements to apply a variable electronic tilt to an antenna beam generated by the antenna array.

As discussed above with reference to the embodiments of FIGS. 7A-7B, 8 and 12, parasitic elements may be mounted adjacent the radiating elements in a linear array so that the linear array will generate antenna beams that have electronic tilt angles that vary as a function of azimuth angle. As discussed above with respect to FIGS. 14A-14C, a linear array of radiating elements may be configured to generate antenna beams that exhibit a variable electronic downtilt where the outer portions of the main lobe of the antenna beam are downtilted more than the central portion of the main lobe. This can be accomplished, for example, by configuring the radiating elements in the linear array so that a phase lag/lead exists between the lower radiating elements in the linear array and the upper radiating elements in the linear array, where the amount that the phase of the RF energy emitted by the lower radiating elements lags or leads the phase of the RF energy emitted by the upper radiating elements increases with increasing divergence from the boresight pointing direction in the azimuth plane, as shown in FIG. 14C. The embodiment of FIGS. 14A-14C uses a stepped reflector to configure the phase of the upper radiating elements in the linear array to lead the phase of the lower radiating elements in the linear array (where the amount of phase lead increases with increasing divergence from the boresight pointing direction in the azimuth plane). When parasitic elements are used to generate such a variable phase lag/lead (i.e., a phase lag or lead that increases with increasing divergence from the boresight pointing direction in the azimuth plane), the parasitic elements that are positioned adjacent at least some of the radiating elements are typically configured differently than the parasitic elements that are positioned adjacent other of the radiating elements so that each parasitic element may change the phase of an associated (adjacent) radiating element in a desired fashion.

For example, in an application where it is desired to have the outer portions of a main lobe of an antenna beam be downtilted more than the central portion of the main lobe, the parasitic elements adjacent the lower radiating elements in the linear array may be configured to generate a relative phase lag (at least at azimuth angles that correspond to the outer portions of a sector covered by the linear array) with respect to the RF energy emitted by the radiating elements in the lower portion of the linear array, while the parasitic elements adjacent the upper radiating elements in the linear array may be configured to generate a relative phase lead (at least at azimuth angles that correspond to the outer portions of a sector covered by the linear array) with respect to the RF energy emitted by the radiating elements in the upper portion of the linear array. The amount of phase lag/phase lead applied by each parasitic element may be set, for example, so that the radiating elements have a linear phase lag/lead response, with the lowermost radiating element in the linear array having the largest phase lag and the uppermost radiating element in the linear array having the largest phase lead, and the phase difference between adjacent radiating elements in the array being approximately equal. It will be appreciated, however, that many variations are possible, such as having groups of adjacent radiating elements all having the same phase lag or phase lead, or having unequal phase differences between adjacent radiating elements in the linear array.

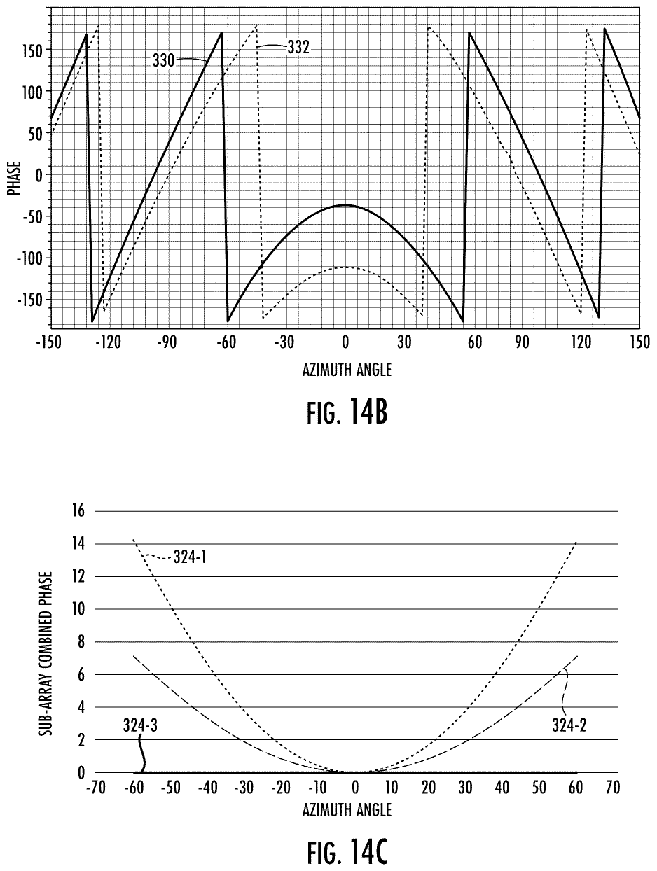

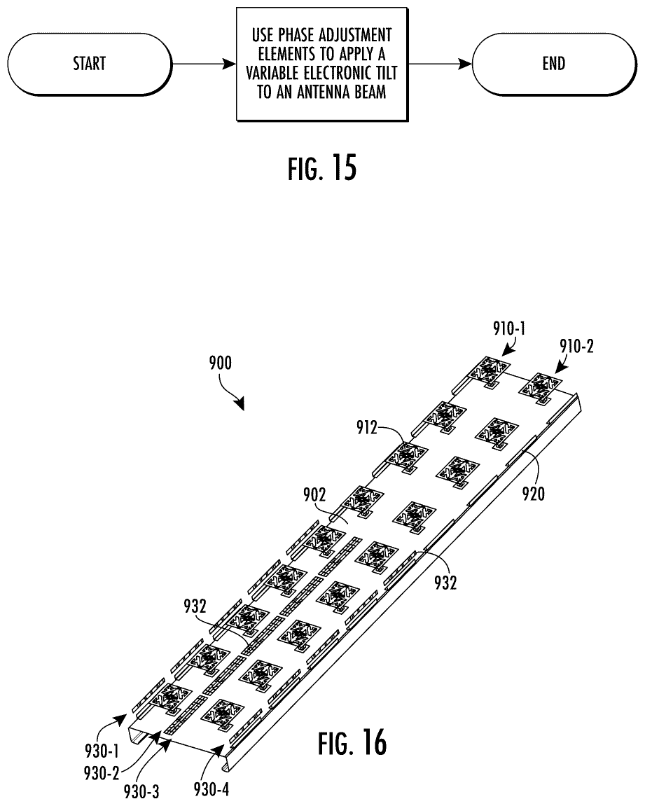

FIG. 16 is a schematic perspective view of a base station antenna 900 according to further embodiments of the present invention. As shown in FIG. 16, base station antenna 900 includes first and second low-band linear arrays 910-1, 910-2. Each low-band linear array 910 comprises a plurality of low-band radiating elements 912 that are arranged in a column that extends in the longitudinal direction of base station antenna 900. Each radiating element 912 is mounted on a respective feedboard 914, and the feedboards 914 are mounted on a reflector 902. Base station antenna 900 also includes a plurality of isolation walls 920 that are positioned along the sides of the reflector 902 outwardly of the respective radiating elements 912. The isolation walls 920 are configured to redirect RF radiation that is emitted by the radiating elements 912 of linear array 910-1 at large negative azimuth angles and RF radiation that is emitted by the radiating elements 912 of linear array 910-2 at large positive azimuth angles to be directed at azimuth angles that are closer to the boresight azimuth angle of base station antenna 900 in order to improve the sector power ratios of linear arrays 910-1, 910-2. It will be appreciated that various elements of base station antenna 900 are not shown in FIG. 16, such as a radome and end caps, RF ports, feed networks, and linear arrays of radiating elements that operate in other frequency bands in order to simplify the drawings. The same is true with respect to base station antennas 950, 1000, 1050 that are discussed below with reference to FIGS. 17A, 18A and 19A.

Base station antenna 900 also includes four columns 930-1 through 930-4 of parasitic elements 932. The first and fourth columns 930-1, 930-4 are mounted along the sides of the reflector 902 (and forwardly thereof) outside of the five lowermost radiating elements 912 of each linear array 910. The second and third columns 930-2, 930-3 are mounted to extend forwardly from the center of the reflector 902. As a result, each of the five lowermost radiating elements 912 in linear arrays 910-1, 910-2 has a parasitic element mounted on either side thereof. Each parasitic element 932 may be configured to adjust the phase of RF signals that are incident thereon in order to impart a variable electronic downtilt to the antenna beams generated by linear arrays 910-1, 910-2. For example, each parasitic element 932 may be configured to generate a phase lag with respect to RF radiation incident thereon.

As discussed above, a variable electronic downtilt (or uptilt) is generated by applying a relative phase lag or lead to the RF energy emitted by certain radiating elements in a linear array at azimuth angles corresponding to the edges of the coverage area of the linear array as compared to the RF energy emitted by other radiating elements in the linear array at those azimuth angles. In some embodiments, parasitic elements 932 may only be positioned adjacent some of the radiating elements in a linear array, as is shown in FIG. 16. For example, in base station antenna 900, parasitic elements 932 are only positioned by the lowest five radiating elements 912 in each linear array 910 and are configured to impart a phase lag to the RF energy emitted by these radiating elements 912 at azimuth angles corresponding to the edges of the coverage area with respect to the RF energy emitted by the upper four radiating elements 912 in each linear array 910 at those azimuth angles. In some embodiments, all of the parasitic elements 932 may have the same design, in which case the RF energy emitted by all five of the lower radiating elements 912 in each linear array 910 will have the same phase lag as a function of azimuth angle with respect to the RF energy emitted by the four upper radiating elements 912 in the respective linear arrays 910. This results in a two-step phase taper. In other embodiments, the parasitic elements 932 that are adjacent the lowermost radiating elements 932 in each linear array 910 (e.g., the three lowest radiating element in each linear array 910) may have a first design that imparts a first amount of phase lag to the RF energy emitted by the adjacent radiating elements 912 and the parasitic elements 932 that are adjacent the other ones of the lower five radiating elements 932 in each linear array 910 (e.g., the fourth and fifth lowest radiating elements 912 in each linear array 910) may have a second design that imparts a second amount of phase lag to the RF energy emitted by the adjacent radiating elements 912. This results in a three-step phase taper which may provide improved performance. Thus, as shown in FIG. 16, in some embodiments parasitic elements may be positioned adjacent only a subset of the radiating elements in a linear array.

FIG. 17A is a schematic front view of a base station antenna 950 according to further embodiments of the present invention. As shown in FIG. 17A, base station antenna 950 includes first and second low-band linear arrays 960-1, 960-2. Each low-band linear array 960 comprises a plurality of low-band radiating elements 912 that are arranged in a column that extends in the longitudinal direction of base station antenna 950. Base station antenna 950 also includes a plurality of isolation walls 920 and four columns of parasitic elements 932 that are configured to adjust the phase of RF signals that are incident thereon in order to impart a variable electronic downtilt to the antenna beams generated by linear arrays 960-1, 960-2. The radiating elements 912, the isolation walls 920 and the parasitic elements 932 may be identical to the like-numbered elements of base station antenna 900 and hence further description thereof will be omitted.

Base station antenna 950 differs from base station antenna 900 in that the spacing between the uppermost two radiating elements 912 of linear array 960-1 and the corresponding uppermost two radiating elements 912 of linear array 960-2 that are horizontally-aligned therewith are spaced apart from each other by a larger spacing than the spacings between the bottommost seven radiating elements 912 of linear array 960-1 and their corresponding horizontally-aligned radiating elements 912 of linear arrays 960-2. In the example of FIG. 17A, the two radiating elements in the uppermost two “rows” of radiating elements 912 in base station antenna 950 have a center-to-center spacing of 290 mm, while the remaining seven pairs of horizontally-aligned radiating elements 912 have a center-to-center spacing of 260 mm. FIG. 17B is a table that shows the phase change attributable to the different spacing between pairs of horizontally-aligned radiating elements 912 in the base station antenna 950 of FIG. 17A. In FIG. 17B, the phase change attributable to the different spacing between pairs of horizontally-aligned radiating elements 912 refers to the relative phase difference between a “first” radiating element, which is one of the lower seven radiating elements 912 in the first linear array 960-1 and a “second” radiating element, which is one of the two upper radiating elements 912 in the first linear array 960-1. Thus, assuming, for example, that the phase of the first radiating element is 0° at azimuth angles of both −60° and +60°, then FIG. 17B shows that the phase of the second radiating element will be −23.5° at an azimuth angle of −60° and +41.4° at an azimuth angle of +60° due to the fact that the first and second radiating elements 912 are spaced apart from adjacent radiating elements in linear array 960-2 by different distances. Thus, as shown in FIG. 17B, reducing the spacing between the seven lower pairs of horizontally-aligned radiating elements 912 acts to generate a phase lead/lag between the seven lowest radiating elements 912 in each linear array 960-1, 960-2 and the two uppermost radiating elements 912 in the respective linear arrays 960-1, 960-2. As can be seen in FIG. 17B, the amount of phase change varies with respect to both frequency (FIG. 17B shows the phase change at three exemplary frequencies) and also is asymmetrical with respect to the amount of variable electronic downtilt that is applied on each side of the sector (i.e., at −60° versus +60°).

The phase of the RF radiation emitted by a radiating element on an infinite reflector will typically be symmetrical in the horizontal plane. However, in practical antennas, the reflector is not infinite, and there are often other nearby arrays of radiating elements that can alter the phase so that it is no longer symmetrical. This is particularly true in the scenario shown in FIG. 17A where two arrays that operate in the same frequency band are positioned side-by-side on the reflector. As shown in FIG. 17B, the phase change that is attributable to the use of different radiating elements is highly positive at all frequencies at +60° and is highly negative over much of the frequency band at −60°, and only slightly positive even at the low end of the low-band operating frequency band. Thus, FIGS. 17A-17B show that by using different radiating element spacings between different horizontally-aligned pairs of radiating elements in two side-by-side linear arrays, it may be possible to compensate for the asymmetries that naturally occur, which can improve performance.

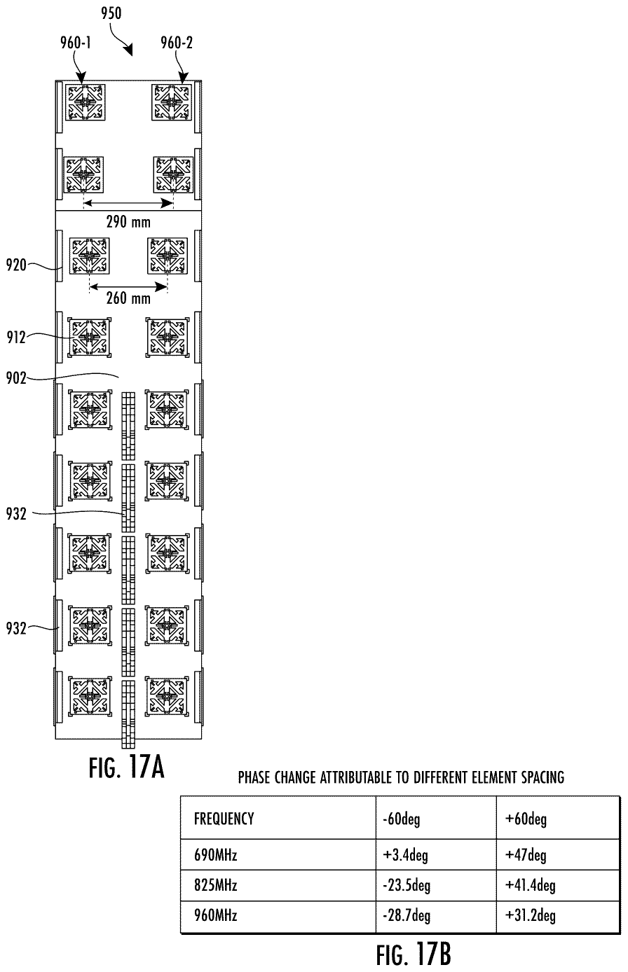

FIG. 18A is a schematic front view of a base station antenna 1000 according to further embodiments of the present invention. As shown in FIG. 18A, base station antenna 1000 includes first and second low-band linear arrays 1010-1, 10160-2. Each low-band linear array 1010 comprises a plurality of first low-band radiating elements 912 and a plurality of second low-band radiating elements 1012 that are arranged in a column that extends in the longitudinal direction of base station antenna 1000. Base station antenna 1000 also includes the isolation walls 920 and four columns of parasitic elements 932 that are discussed above with respect to base station antenna 900.

Base station antenna 1000 differs from base station antenna 900 in that two different types of low-band radiating elements 912, 1012 are used to form each low-band linear array 1010-1, 1010-2. The first and second low-band radiating elements 912, 1012 may have different phase centers, and hence the use of different types of radiating elements may create a phase taper that may be used to configure a linear array 1010 to generate antenna beams having variable electronic downtilt. In addition, the coupling between a horizontally-aligned pair of first low-band radiating elements 912 may differ from the coupling between a horizontally-aligned pair of second low-band radiating elements 1012, and these differences in coupling can also generate a phase lead/lag that can further contribute to the generation of antenna beams having variable electronic downtilt. In the example of FIG. 18A, the lowermost five low-band radiating elements in each linear array 1010 are implemented using first low-band radiating elements 912 while the uppermost four low-band radiating elements in each linear array 1010 are implemented using second low-band radiating elements 1012. As shown in FIG. 18B, using the two different types of radiating elements 912, 1012 to implement linear arrays 1010-1, 1010-2 acts to generate a phase lead/lag between the RF energy emitted by the first radiating elements 912 and the second radiating elements 1012. As can be seen in FIG. 18B, the amount of phase change varies with respect to frequency and is asymmetric with respect to the amount of variable electronic downtilt that is applied on each side of the sector (i.e., at −60° versus +60°).

While FIG. 18A shows an example base station antenna 1000 in which each linear array 1010 includes two different types of radiating elements 912, 1012, it will be appreciated that embodiments of the present invention are not limited thereto. For example, in other embodiments three, four or more different types of radiating elements may be used to implement one or both of the linear arrays 1010-1, 1010-2.

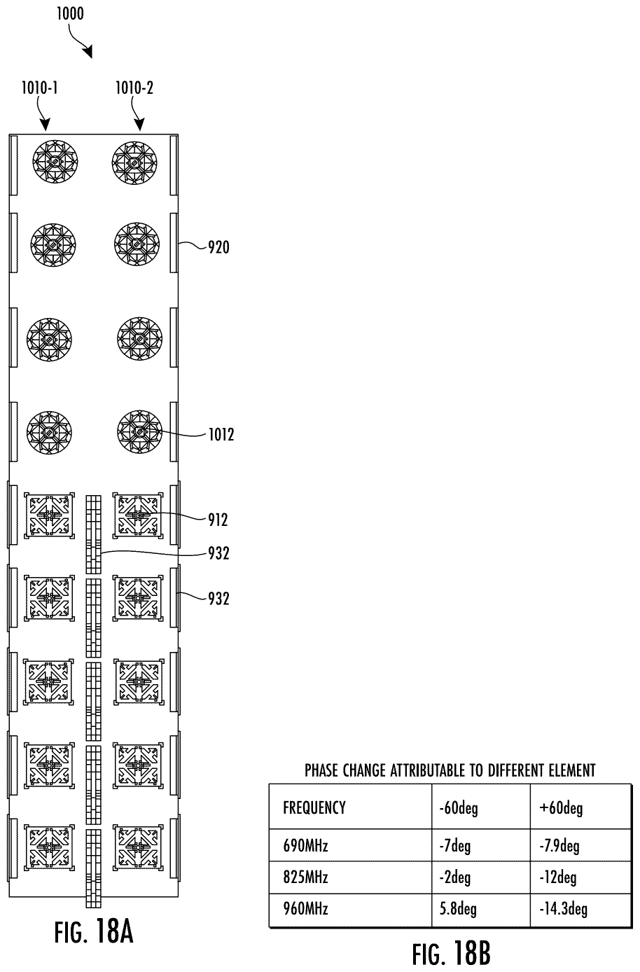

FIG. 19A is a schematic perspective view of a base station antenna 1050 according to still further embodiments of the present invention. FIG. 19B is a schematic perspective view of one of the low-band radiating elements 1062 included in base station antenna 1050. As shown in FIG. 19A, base station antenna 1050 includes first and second low-band linear arrays 1060-1, 1060-2. Each low-band linear array 1060 comprises a plurality of low-band radiating elements 912, 1062 that are arranged in a column that extends in the longitudinal direction of base station antenna 1050. Each low-band linear array 1060 includes both first low-band radiating elements 912 and third low-band radiating elements 1062. Each third low-band radiating element 1062 includes a feed stalk 1064, a pair of cross-dipole radiators 1066-1, 1066-2 and a plurality of parasitic monopole elements 1068 that interact with the RF energy emitted by the cross-dipole radiators 1066-1, 1066-2 (and also with the cross-dipole radiators 1066-1, 1066-2 of the low-band radiating elements 1062 in the adjacent liner array 1060) in a manner that acts to significantly narrow the azimuth HPBW of the generated low-band antenna beams. U.S. patent application Ser. No. 19/208,454, filed May 14, 2025 (“the '454 application”) discloses various radiating element designs that include such parasitic monopole elements. The entire content of the '454 application is incorporated by reference herein. Any of the radiating element designs disclosed in the '454 application may be used to implement the third low-band radiating elements 1062 included in linear arrays 1060-1, 1060-2.

Base station antenna 950 also includes a plurality of isolation walls 920 and four columns of parasitic elements 932 that are configured to adjust the phase of RF signals that are incident thereon in order to impart a variable electronic downtilt to the antenna beams generated by linear arrays 1060-1, 1060-2. The isolation walls 920 and parasitic elements 932 may be identical to the like-numbered elements of base station antenna 900 and hence further description thereof will be omitted.

Base station antenna 1050 of FIG. 19A differs from base station antenna 900 of FIG. 16 in that the lowermost low-band radiating elements in linear arrays 1060 of base station antenna 1050 are implemented using the third low-band radiating elements 1062 as opposed to the first low-band radiating elements 912. It has been found that replacing some of the first low-band radiating elements 912 with third low-band radiating elements 1062 has little impact on the phase difference between the individual radiating elements 912, 1062 in each low-band linear array 1060. This is shown in FIG. 18C, which shows that adding parasitic monopole elements 1068 to a first low-band radiating element 912 (to create a third low-band radiating element 1062) has very little impact on the relative phases of the RF energy emitted by different low-band radiating elements 912, 1062 in each low-band linear array 1060). However, as discussed in the '454 application, the addition of the parasitic monopole elements 1068 may significantly reduce the azimuth beamwidths of the antenna beams generated by linear arrays that include radiating elements having parasitic monopole elements. The reduced azimuth beamwidths may improve the SINR performance of a linear array because, particularly with low-band arrays, the azimuth beamwidth is typically somewhat larger than desired, and hence the use of low-band radiating elements that include parasitic monopole elements may reduce the azimuth beamwidth of the generated antenna beams, increasing the gain within the sector served by base station antenna 1050 and reducing the amount of RF energy that falls within neighboring sectors, both of which may contribute to improved SINR performance. As shown in FIG. 19A, less than all of the low-band radiating elements in linear arrays 1060-1, 1060-2 may be implemented using the third low-band radiating elements 1062 in order to maximize desired performance parameters. For example, if the azimuth beamwidth is reduced too much, then coverage near the edges of the sector may be poor. Thus, performance tradeoffs may make it advantageous to only implement some of the low-band radiating elements in linear arrays 1060-1, 1060-2 using the third low-band radiating elements 1062.

As can be seen in the tables of FIGS. 17B, 18B and 19C, the amount of phase change that different techniques for generating phase lags/leads between the radiating elements in a linear array tend to vary with frequency. As such, the amount of variable electronic downtilt that is applied may vary based on the frequency of the RF signals that are transmitted and received through a linear array. This means that the SINR and/or coverage performance of a linear array that is configured to apply variable electronic downtilts to the generated antenna beams may vary as a function of the frequency of the RF signals that are transmitted through the linear array.

The variation in phase change as a function of frequency may occur, for example, because the techniques (e.g., parasitic elements, different radiating element designs, etc.) may have a phase response that varies with frequency and which may be a generally narrowband response. Thus, using parasitic elements as an example, a given parasitic phase change element may generate a relatively large amount of phase change at the center frequency of the operating frequency band of a linear array, yet generate substantially less phase change for RF signals at the lowermost and/or uppermost frequencies of the operating frequency band.

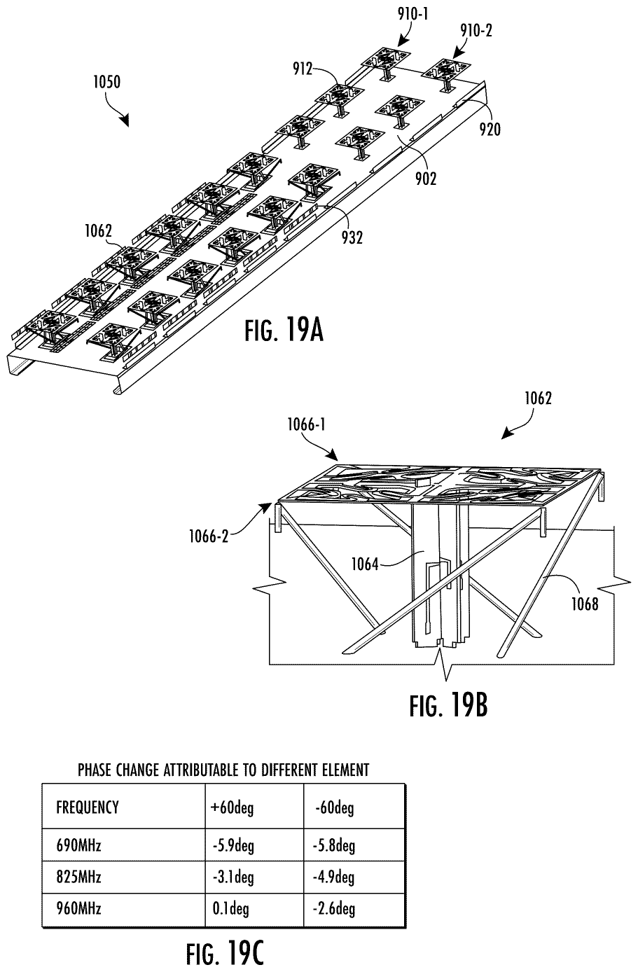

In order generate more consistent amounts of phase change across the operating frequency band of a linear array, wideband parasitic element designs may be used. FIG. 20A is a schematic view of a wideband parasitic element 1100 according to embodiments of the present invention. As shown in FIG. 20A, wideband parasitic element 1100 includes three parasitic elements 1110, 1120, 1130, each of which are implemented on a respective printed circuit board (although in other embodiments all three parasitic elements 1110, 1120, 1130 could be implemented on a single printed circuit board). Each parasitic element 1110, 1120, 1130 may have a different resonant frequency. RF energy emitted by a radiating element adjacent wideband parasitic element 1100 will impinge on all three parasitic elements 1110, 1120, 1130, and hence will undergo a phase change that is based on the amount of RF energy incident on each individual parasitic element 1110, 1120, 1130 and the amount of phase change imparted by the individual parasitic elements 1110, 1120, 1130 at the frequency of the RF signal. The wideband parasitic element 1100 may reduce the amount of variation in phase change as a function of frequency, and hence may help make the amount of variable electronic downtilt that is applied to the antenna beams that are generated by the linear arrays of a base station antenna that includes the wideband parasitic elements 1100 more uniform as a function of frequency.

FIG. 20B is a graph that illustrates the phase change responses of the three individual parasitic elements 1110, 1120, 1130 shown in FIG. 20A.

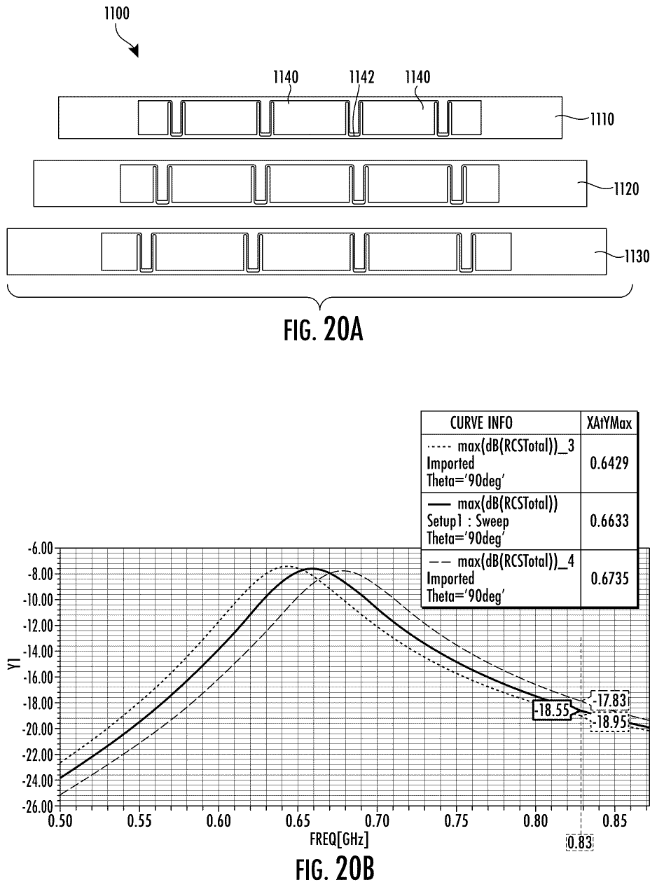

As discussed above, parasitic elements may be used to induce a variable electronic downtilt to the RF radiation emitted by a linear array. This is typically done by applying a phase lag to the radiating elements emitted by at least some of the radiating elements in the linear array in the manner described in detail above with respect to FIGS. 14A-14C. Pursuant to further embodiments of the present invention, parasitic elements may be used that will impart a phase lead to RF radiation emitted by at least one or more of the radiating elements in a linear array. For example, FIG. 21 is a schematic front view of a base station antenna 1150 according to further embodiments of the present invention that includes both phase lag and phase lead parasitic elements. As shown in FIG. 21, base station antenna 1150 includes first and second linear arrays 1160-1, 1160-2 of low-band radiating elements 912 and a plurality of parasitic elements 932, 1172. The parasitic elements 932 may be positioned on either side of the radiating elements 912 in the lower portions of the linear array 1160 while the parasitic elements 1172 may be positioned in front of the radiating elements 912 in the upper portion of each linear array 1160. The parasitic elements 1172 are shown schematically as transparent boxes to show the radiating elements 912 mounted behind each parasitic element 1172. The parasitic elements 1172 may be implemented, for example, as electrically floating (i.e., not grounded) metamaterial phase control surfaces. It is believed that such metamaterial parasitic elements 1172 may be designed to impart phase leads (at the edges of the sector) to RF energy emitted by the radiating elements 1162 that are mounted rearwardly of (and overlapping in the forward direction) the respective metamaterial parasitic elements 1172.

One advantage of having some parasitic elements 932 generate phase lags (at the sector edges) while other parasitic elements 1172 generate phase leads is that the total amount of phase change can be increased, and hence the degree that the outer portions of the generated antenna beams are uptilted or downtilted relative to the center of the main lobe can be increased, which may be advantageous in some applications.

Pursuant to further embodiments of the present invention, parasitic elements are provided that can be used in the above-described base station antennas according to embodiments of the present invention where the parasitic elements can have primarily indictive or capacitive responses to apply either a phase lag (inductive response) or a phase lead (capacitive response) to RF radiation in the operating frequency band of an associated linear array that is incident on the parasitic element. For example, the parasitic elements 1110, 1120, 1130 that are included in the wideband parasitic element 1100 of FIG. 20A comprise widened conductive segments 1140 that are coupled by narrow U-shaped meandered traces 1142. While there is a small edge capacitance between adjacent conductive segments 1142, the long, narrow traces 1142 exhibit a relatively high inductance so that each parasitic element 1110, 1120, 1130 will exhibit a primarily inductive response. This response will impart a phase lag to RF radiation in the operating frequency band of an associated linear array that is incident on the parasitic element. If instead the parasitic elements were designed to have a primarily capacitive response, then the parasitic element will impart a phase lead to RF radiation in the operating frequency band of an associated linear array that is incident on the parasitic element.

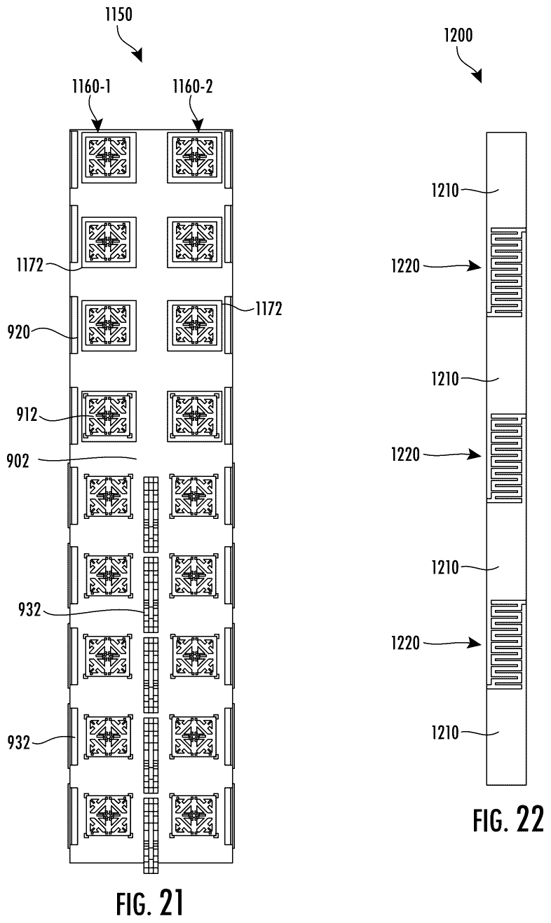

FIG. 22 is a schematic view of a parasitic element 1200 according to further embodiments of the present invention that has a primarily capacitive response. As shown in FIG. 22, the parasitic element 1200 comprises a plurality of widened conductive segments 1210. Adjacent conductive segments are capacitively coupled to each other through interdigitated capacitors 1220. Parasitic elements having the design of parasitic element 1200 may be used in the base station antennas according to embodiments of the present invention to impart a phase lead to RF radiation in the operating frequency band of an associated linear array that is incident on the parasitic element.

While in the above discussion each linear array has its own set of parasitic elements that are configured to induce a variable electronic downtilt to the RF radiation emitted by the respective linear arrays, it will be appreciated that in other embodiments multiple linear arrays may share at least some of the parasitic elements so that less overall parasitic elements are required.

Embodiments of the present invention have been described above with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

Herein, the terms “substantially” and “approximately” mean within +/−10%.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

1. A base station antenna, comprising:
an array of radiating elements that is configured to generate an antenna beam having a main lobe that has a first amount of electronic downtilt in a first pointing direction in the azimuth plane and that has a second amount of electronic downtilt in a second pointing direction in the azimuth plane, where the second amount of electronic downtilt exceeds the first amount of electronic downtilt by at least 1°.

2-3. (canceled)

4. The base station antenna of claim 1, wherein the second amount of electronic downtilt exceeds the first amount of electronic downtilt by at least 5°.

5. The base station antenna of claim 1, wherein the first pointing direction in the azimuth plane is a boresight pointing in the azimuth plane.

6-7. (canceled)

8. The base station antenna of claim 5, wherein the second pointing direction in the azimuth plane is at an azimuth angle that is between −60° and −30° or at an azimuth angle that is between 30° and 60°.

9. The base station antenna of claim 1, wherein the base station antenna is a sector antenna of a cellular network, and the antenna beam that is generated by the array is configured to cover a 120° sector in the azimuth plane.

10. The base station antenna of claim 1, wherein the main lobe has an amount of electronic downtilt as a function of azimuth angle that monotonically increases over a first range of at least 10° of the azimuth angles subtended by the main lobe.

11. The base station antenna of claim 10, wherein the main lobe has an amount of electronic downtilt as a function of azimuth angle that monotonically increases over a second range of at least 10° of the azimuth angles subtended by the main lobe, where the first range does not overlap the second range.

12. The base station antenna of claim 11, wherein an azimuth angle corresponding to a boresight pointing direction of the main lobe is in between the first range and the second range.

13-24. (canceled)

25. A base station antenna, comprising:
a first radio frequency (“RF”) port;
an antenna array that includes a plurality of radiating elements, each radiating element including a first polarization radiator, where the first polarization radiator of each radiating element in the antenna array is coupled to the first RF port; and
an adjustable pattern control system that is configured to adjust an average amount of electronic downtilt applied to a first outer portion of a main lobe of an antenna beam that is generated in response to an RF signal input at the first RF port relative to an average amount of electronic downtilt applied to a central portion of the main lobe, where the first outer portion of the main lobe comprises a first portion of the main lobe that is directed at a first range of azimuth angles and the central portion of the main lobe comprises a second portion of the main lobe that is directed at a second range of azimuth angles that do not overlap with the first range of azimuth angles and that are closer to an azimuth angle of the boresight pointing direction of the antenna beam than the azimuth angles in the first range of azimuth angles.

26. The base station antenna of claim 25, wherein the adjustable pattern control system is further configured to adjust an average amount of electronic downtilt applied to a second outer portion of the main lobe relative to the average amount of electronic downtilt applied to the central portion of the main lobe, where the second outer portion of the main lobe comprises a third portion of the main lobe that is directed at a third range of azimuth angles that do not overlap with the second range of azimuth angles.

27. The base station antenna of claim 26, wherein the second range of azimuth angles is in between the first and third ranges of azimuth angles.

28. The base station antenna of claim 27, wherein the second range of azimuth angles comprises azimuth angles that are less than 30° from the azimuth angle of the boresight pointing direction of the antenna beam, the first range of azimuth angles comprises azimuth angles that are between −30° and −60° of the azimuth angle of the boresight pointing direction of the antenna beam, and the third range of azimuth angles comprises azimuth angles that are between 30° and 60° of the azimuth angle of the boresight pointing direction of the antenna beam.

29. (canceled)

30. The base station antenna of claim 25, wherein the antenna beam is configured to provide coverage to a 120° sector in the azimuth plane of a cell of a cellular network.

31. (canceled)

32. The base station antenna of claim 28, wherein the adjustable pattern control system is configured to apply at least 2° more electronic downtilt, on average, to the first outer portion of the main lobe of the antenna beam than is applied, on average, to the central portion of the antenna beam.

33. The base station antenna of claim 25, further comprising a remote electronic tilt system that is configured to adjust the boresight pointing direction of the antenna beam in the elevation plane in response to control signals received from a remote location.

34-70. (canceled)

71. A base station antenna, comprising:
a reflector that extends in a longitudinal direction of the base station antenna;
an antenna array that includes a plurality of radiating elements, the antenna array configured to generate antenna beams that provide coverage to a sector of a cellular communications system; and
a variable electronic tilt system that is configurable to adjust a difference between a first amount of electronic downtilt that is applied to the generated the antenna beams at the center of the sector and a second amount of electronic downtilt that is applied to the generated antenna beams at the edge of the sector.

72-78. (canceled)

79. A base station antenna, comprising:
an antenna array that includes a plurality of radiating elements that are spaced apart from each other in a longitudinal direction of the base station antenna, the antenna array configured to generate antenna beams that provide coverage to a sector of a cellular communications system; and
wherein the antenna array is configured so that a first phase of first RF radiation emitted by a first subset of the radiating elements in an upper portion of the antenna array toward a center of the sector is equal to a second phase of second RF radiation emitted by a second subset of the radiating elements in a lower portion of the antenna array toward the center of the sector, and so that a third phase of third RF radiation emitted by the first subset of the radiating elements toward a first edge of the sector differs from a fourth phase of fourth RF radiation emitted by the second subset of the radiating elements toward the first edge of the sector.

80. The base station antenna of claim 79, wherein the third phase differs from the fourth phase by at least 5°.

81. The base station antenna of claim 79, wherein the antenna array is further configured so that a fifth phase of fifth RF radiation emitted by the first subset of the radiating elements toward a second edge of the sector differs from a sixth phase of sixth RF radiation emitted by the second subset of the radiating elements toward the second edge of the sector.

82. The base station antenna of claim 81, wherein a difference between the third phase and the fourth phase is the same as a difference between the fifth phase and the sixth phase.

83-101. (canceled)
